(19) United States
(12) Patent Application Publication
(10) Pub. No.: US 2024/0138001 A1
(43) Pub. Date: Apr. 25, 2024

(54) SIDELINK OPTIMIZATION FOR IOT RELAYING

(71) Applicant: Telefonaktiebolaget LM Ericsson (PUBL), Stockholm (SE)

(72) Inventors: Andreas Höglund, SOLNA (SE); Olof Liberg, ENSKEDE (SE); Yi-Pin Eric Wang, FREMONT, CA (US)

(21) Appl. No.: 18/546,365

(22) PCT Filed: Feb. 14, 2022
(86) PCT No.: PCT/SE2022/050164

§ 371 Date: Aug. 13, 2023

Related U.S. Application Data
(60) Provisional application No. 63/149,386, filed on Feb. 15, 2021.

(51) Int. Cl. H04W 76/14; H04W 60/02; H04W 76/28

(52) U.S. Cl. CPC H04W 76/14; H04W 60/02; H04W 76/28; H04W 92/18

(57) ABSTRACT

A first wireless communication device (401, 404), WCD, transmits a first indication to a second WCD (401, 404) or receives a first indication from the second WCD. The first indication indicates a first time period (501) during which the first WCD is expected to monitor for receipt of a transmission. The first WCD monitors for receipt of a transmission during the first time period. The first WCD is not expected to monitor for receipt of a transmission during a second time period (502) before the first time period begins. The first WCD performs the transmission or receipt of the first indication after a link has been established between the first WCD and the second WCD for relaying of information to and/or from a network via one or more sidelink transmissions between the first WCD and the second WCD.

### TECHNICAL FIELD

The present disclosure generally relates to wireless communication, and in particular to relaying for internet of things (IoT) devices.

### BACKGROUND

### Sidelink Communication

Sidelink (SL) communication is introduced in 3rd generation partnership project (3GPP) long term evolution (LTE) release 12, focusing on public safety use cases for the support of one-to-many communications. In release 13, SL communication is enhanced to support user equipment (UE) based relaying to extend the network coverage. It includes the support of one-to-one SL communication, which is performed on the application layer transparent to the access stratum.

From release 14-release 15, SL communication is enhanced to support a new set of use cases, called vehicle-to-vehicle and vehicle-to-infrastructure communications (V2X) using LTE. With the support of the new radio (NR) radio interface introduced in release 15, NR based SL communication has been studied in release 16 to support enhanced V2X services. In release 17, there is a study item on single-hop (relay) SL communication over NR-SL (see for example the 3GPP document RP-193253 entitled ‘New SID: Study on NR sidelink relay’).

The following sections provide a brief background description of the NR-SL interface designed for V2X application. For more details about the NR-SL interface, see for example 3GPP TR 38.885 v16.0.0, TS 38.331 v16.3.1, TS 38.211 v16.4.0, TS 38.214 v16.4.0, TS 38.321 v16.3.0, TS 24.386 v16.2.0, TS 24.334 v17.0.0, and TS 24.587 v17.0.0.

### NR-SL Protocol Stacks

FIG. 1a shows the user plane (UP) protocol stack for the sidelink interface, which is also referred to as a PC-5 (or PC5) interface. The UP protocol stack includes service data adaption protocol (SDAP), packet data convergence protocol (PDCP), radio link control (RLC), medium access control (MAC), and physical (PHY) layers. The major difference between the LTE V2X and NR V2X is that LTE V2X supports only broadcast messaging, while NR V2X supports unicast, multicast, and group cast messaging at access stratum (AS) layers.

FIG. 1b shows the control plane (CP) protocol stack for NR V2X sidelink. It includes PDCP, RLC, MAC, and PHY layers. The control signals are transmitted over Physical Sidelink Control Channel (PSCCH) and can be used to transmit both Radio Resource Control (RRC) (that is, PC5-RRC) and non-access stratum (NAS) signaling (PC5-S). PC5-RRC signaling exchange is started after the initial link setup using PC5-S signaling.

### Unicast Link Establishment

A unicast link establishment procedure in NR-V2X is shown in FIG. 2. In FIG. 2, UE1 is the initiating UE and UE2 is the destination UE. The following pre-conditions should be met by UE1 before initiating the connection establishment:
The upper layer of UE1 has requested to send a packet over PC5.
The application layer identifier (ID) (and hence the layer-2 ID) of UE1 is available. The application layer ID may for example be self-assigned or pre-configured.

The messages involved in the link establishment procedure is described in respective sections below. For more details about the link establishment procedure, see for example 3GPP TR 38.885 v16.0.0, TS 24.386 v16.2.0, 24.334 v17.0.0, and 24.587 v17.0.0.

### Direct Communication Request

UE1 initiates the connection establishment procedure by sending a Direct Communication Request (DCR) message. A DCR contains:
The application layer ID of the UE1.
It may also include the application layer ID of UE2, if known to UE1.
A service identifier of the service that UE1 wants.
A key establishment information container which contains information for PC5 unicast link key establishment.
A Nonce_1 (a random number) set to a 128-bit nonce value produced by UE1 for the key establishment session.
A list of security algorithms that UE1 supports to set-up security over the PC5 unicast link.
KNRP ID (a 256-bit root key to authenticate two UEs), if UE1 has an existing KNRP for UE2 (that is, when there is already a PC5 unicast link between UE1 and UE2).
8 MSBs (Most Significant Bit) of the KNRP-sess ID that are selected by UE1 (KNRp-sess is the 256-bit key to protect the data exchange between the UEs).

Upon reception of the DCR from UE1, UE2 stores the layer-2 ID of UE1. Also, UE2 assigns a unique layer-2 ID for itself (mapped from the application layer-ID of UE2). When UE2 receives the DCR from UE1, UE2 proceeds to a link authentication procedure to derive the KNRP.

### Direct Link Authentication

Direct link authentication is performed for mutually authenticating UE1 and UE2, and to acquire a new security key shared between UE1, and UE2. To initiate the link authentication procedure, UE2 creates a direct link authentication request which includes the Key establishment information container IE (information element) and sends the direct link authentication request to UE1.

After receiving the direct link authentication request, UE1 decides whether to accept or reject the link based on the information contained in the Key establishment information container. If UE1 accepts the direct link authentication request, UE1 will create a direct link authentication response message towards UE2. If UE2 receives a direct link authentication reject message, UE2 aborts the unicast link establishment procedure.

### Direct Link Security Mode Control

The direct link security mode control is used to set-up security between UE1 and UE2 in the course of the unicast connection establishment. UE2 initiates the procedure by sending a direct link security mode command to UE1. If UE1 accepts the direct link security mode command, UE1 will respond to UE2 by sending a direct link security mode complete message. After the successful security mode control, keys and security algorithms are employed to integrity protect and cipher all SL data communicated between UE1 and UE2. If UE2 receives the direct link security mode reject message, UE2 aborts the unicast link establishment procedure.

### Direct Link Communication Accept

After the successful direct link security mode control, UE2 will send a Direct Communication Accept (DCA) message to UE1. A DCA message contains the following information:
Application layer ID of UE2
PC5 quality of service (QoS) Flow ID (PQFI) and the corresponding QoS parameters.

### Unicast Data Transmission

Upon receiving the unique application layer ID of UE2 in DCA, UE1 now has the application layer ID of UE2. UE1 stores the application layer ID of UE1 and UE2, and this pair of application layer IDs acts as a PC5 link identifier for the PC5 link between UE1 and UE2. After receiving the DCA, UE1 starts sending data to UE2, and UE1 tags each protocol data unit with the derived PC5 link identifier. Similarly, UE2 can also send data to UE1 using the PC5 link that has now been established.

### Connection Release and Connection Alive

After the data transfer, the communicating peer UEs can either keep the unicast link alive or release the link. Hence, there are two signaling mechanisms.

### Keep the Unicast Link Alive

A unicast link keep-alive procedure is performed to keep the PC5 unicast link alive between UE1 and UE2. To initiate the connection alive procedure, UE1 sends a direct link keep-alive request to UE2 over the existing PC5 link. UE1 has a keep-alive timer T5003 and a keep-alive counter to monitor the activities over the existing PC5 link between UE1 and UE2. A periodic actuation of the PC5 unicast link keep-alive procedure is triggered by the timer T5003. Also, every time UE1 receives an SL signaling message or SL user plane data from UE2, UE1 restarts the timer T5003. The direct link keep-alive request message contains the following information:
Keep-alive counter for the PC5 unicast link.
It optionally also includes a maximum inactivity period of UE1 over the existing PC5 link.

The maximum inactivity period is UE specific. The maximum inactivity period value of UE1 is chosen with an objective to keep the number of keep-alive transmissions to the lowest value possible. After receiving the ‘direct link keep-alive request’, UE2 will create a ‘direct link keep alive response’ message which includes a keep-alive counter value, and it is set to a value that is the same as what is received in the direct link keep-alive request message. When UE1 receives the direct link keep alive response message, UE1 restarts the timer T5003 and also increment the keep-alive counter. After the successful transmission of the direct link keep-alive request and response, the existing PC5 link identifier is used for the future communication between the two UEs. This stored PC5 link identifier enables to skip direct link authentication and direct link security mode command procedure in the subsequent periods.

### Release the Link

The connection release procedure is performed to release the existing PC5 unicast link between UE1 and UE2 and can be initiated from either UE1 or UE2. The initiating UE will create a direct link release request, send it to the destination UE using the existing PC5 link identifier. The following cause values indicate the reason for the connection release. The direct link release request from the initiating UE may contain one of these cause values:
#1: direct communication with the destination UE not allowed
#2: direct communication to the destination UE is not needed.
#4: direct connection is not available anymore.
#5 lack of resources for PC5 unicast link.

After receiving the direct link release request, the destination UE will stop the ongoing communication over the given PC5 link and then respond to the initiating UE with a direct link release accept message. Once the direct link release accept message is sent by the destination UE, the PC5 unicast link is released by the destination UE.

### Resource Allocation

NR sidelink transmissions have the following two modes of resource allocations:
Mode 1: Sidelink resources are scheduled by a NR base station (gNodeB).
Mode 2: The UE autonomously selects sidelink resources from a (pre-) configured sidelink resource pool(s) based on a channel sensing mechanism.

For an in-coverage UE, a gNodeB can be configured to adopt Mode 1 or Mode 2. For an out-of-coverage UE, only Mode 2 can be adopted.

### Channel Sensing for Mode-2 Operation

In the mode-2 resource allocation, the UEs choose the resource for their transmissions (such as the messages shown in FIG. 2) from a pre-configured resource pool. A resource may for example be a subchannel in a slot. Here, a subchannel includes a certain number of resource blocks (RB), for example 10 RB. Each RB includes 12 subcarriers. To avoid collisions in the resource selection, a resource sensing procedure (also referred to as a channel sensing procedure) is used. In the resource sensing procedure, the transmitting UE senses the channel to find candidate resources for its SL transmissions. In the resource sensing phase, a transmitting UE detects the Sidelink Control Information (SCI) transmitted by other UEs in the cell (or within range or the transmitting UE).

To reduce the complexity of the sensing procedure, a two-stage SCI principle is used in NR-SL. When a UE performs transmission in a slot, the UE includes the physical sidelink control channel (PSCCH) symbol and the physical sidelink shared channel (PSSCH) symbol in the same slot (that is, data and control signal are sent together in the same slot). The first stage SCI (also referred to as 1st stage SCI) is transmitted on the PSCCH, and the second stage SCI (also referred to as 2nd stage SCI) is carried over the PSSCH (multiplexed with the data). The first stage SCI carries information regarding the PSSCH resource used for transmitting the second stage SCI and data, PSSCH resources reserved for future transmissions, and a priority of the transmission in the first stage SCI. This first stage SCI is decodable by any peer UE in the cell. Based on the information contained in the first stage SCI, the sensing UEs can choose the resources which are not occupied by peer UEs. The second stage SCI carries the remaining scheduling information for the PSSCH which is decodable only by the target UE.

The output of the resource sensing procedure by a UE is a candidate set of resources for its SL transmissions. The candidate resources are those resources which are unoccupied, and also those resources which are occupied by another UE but which have an interference level acceptable at the UE which is selecting the resources. The selection of resources via resource sensing is explained below with reference to FIG. 3.
1. Let us assume that at a slot n, a transmit buffer of a UE receives a packet for transmission. We assume that the UE has been continuously monitoring the SCI transmitted by the other remote UEs (background sensing). The period over which the remote UE senses the SCIs from other UEs is called a sensing window, and the duration of this sensing window can be configured up to 1000 ms (that is, the UE checks the SCI transmitted from the other UEs within a window that is up to 1000 ms long before the n^{th} slot). In FIG. 3, the sensing window spans from (n−T₀) to (n−T_{proc,0}), where T₀ is the sensing window duration, and T_{proc,0} is associated with the UE processing time for decoding the SCI and performing demodulation reference signal (DMRS) measurement.
2. The UE creates a list of resources within the selection window (selection window in FIG. 3: n+T₁ to n+T₂) based on the output of the sensing procedure. Recall that the output of the sensing procedure is a set of resources which are available for a UE to use for its transmission. Here T₁ denotes the UE processing time from the resource selection trigger to the earliest candidate resource. The remote UE makes a list (L1) of potential resources that include all the resources in the selection window except the resources that meet both of the following two conditions:
   The UE has received a first stage SCI from a peer remote UE in the sensing window indicating that the peer remote UE will use this resource for a transmission.
   The UE measures a Reference Signal Received Power (RSRP) on the PSCCH containing the first stage SCI of the peer remote UEs, and checks if this RSRP is higher than a given RSRP threshold (which may be a configurable parameter). If the RSRP is high enough, this may indicate that there would be a collision, but if the RSRP is low enough, it may be fine to reuse the resource.

If these two conditions are met simultaneously, the remote UE excludes the resource from L1. L1 should include at least 20% of all the resources in the selection window after performing step 2. If this condition is not met, the remote UE increases the RSRP threshold by 3 dB, and iteratively executes step 2 until the target of 20% is met.

Then the UE makes a second list (L2) of resources. L2 is derived from L1, such that L2 contains the resources in L1 which have the lowest average Reference Signal Received Power (RSRP) in L1. Here, the average is taken over the sensing window in FIG. 3 that spans from (n−T₀) to (n−T_{proc,0}). The idea of taking the average is to select the subchannel (or RBs) which will have the lowest interference on the UE's transmission. For example, L1 contains two types of resources: A first set of resources that are not being occupied by any peer UEs, and a second set of resources that are being occupied by peer UEs, but have an interference level below the given threshold. Let us consider the second set of resources. For instance, the UE detects at the beginning of the sensing window that subchannel k will be occupied (but with an RSRP less than the threshold), and the UE also detects later in the sensing window that subchannel k will be occupied, but with a different measured RSRP value. Such a scenario is possible since pre-emption is supported in the NR-SL. In this case, the remote UE takes an average over the sensing window duration to find out the average level RSRP on the subchannel k. Hence, the list L2 contains the resources (time and frequency) from L1 which experience the lowest average RSRP. The UE randomly chooses one of the resources (time+frequency) in L2 and reserves it for its transmission. In FIG. 3, the selected resource is shown as the box 301 in slot M. The resource selection made by the UE is only known to the UE itself, meaning that the UE does not broadcast this selection to the other UEs.
3. Since the UE does not broadcast its resource selection, other nearby UEs may choose the same resource for their transmissions. Hence, the UE keeps on sensing the channel until the slot m to identify if some other UE has selected the same resource 301 at slot m. If the UE detects a SCI transmission from another UE indicating a resource reservation at the same resource 301, the UE initiates a resource reselection procedure. This is illustrated in FIG. 3. The box 301 in slot m represents the resource selected by the UE at slot n. Another UE sends a PSCCH reservation in the resource 302 in slot n+1. The PSCCH reservation indicates that the other UE has also selected the resource 301 for a transmission. The UE then initiates a resource reselection procedure.

M−T₃−T₀M−T₃, T₃ mm+T₂

M−T₃−T₀M−T₃, T₃ mm+T₂ For the resource reselection procedure, the UE selects the resources based on the sensing procedure (over the window from to where is the resource re-selection processing time), and by following the procedure mentioned in steps 2 and 3. The selection window for resource reselection spans from slot to. The reselected resource is shown as the box 303 in FIG. 3. If no other UE has reserved the resource 303, the UE sends its PSCCH and PSSCH in the resource 303. Other UEs can now decode the PSCCH of the UE sent in the resource 303, and sense the future resources reserved by the UE. The future resources reserved by the UE are indicated in the first stage SCI transmitted via the PSCCH in the resource 303.

In the example scenario shown in FIG. 3, T_{proc,0}=1 slot, T₃=T_{proc,0}+1 slots, T₁=2 slots, sensing window duration=100 ms or 1000 ms, and T₂ is limited by the packed delay budget (PDB).

In the unicast link (or connection) establishment procedure described above with reference to FIG. 2, while sending the DCR, the UE also reserves a resource for its very next transmission (such as a direct link authentication response) based on the resource sensing performed. This reservation information is included in the first stage SCI. The UE keeps on sensing the channel until the slot where its future resources are reserved, to check if any other peer UE with higher priority (priority information is provided in the first stage SCI) has reserved the same resources. If the UE detects a higher priority reservation from a peer UE, the UE releases the reserved resources and re-starts the connection establishment procedure from the point at which the collision happened. So, the UE performs the sensing again, and chooses a new resource for transmission of the current transmission, and for a future transmission. This reservation interval for the next signaling/data transmission may for example be limited to 1000 ms (or may be equal to the sensing window). If the UE does not detect reservation from a higher priority peer UE, the UE transmits the direct link authentication response in the reserved resource, and also reserves a resource for its very next transmission (direct link security mode complete). This process continues until the connection has been established and a release or keep alive message has been transmitted.

### IoT Relaying

UE-based relaying may be employed to increase coverage. It would be desirable to provide UE-based relaying adapted for IoT devices.

### SUMMARY

Embodiments of methods, wireless communication devices, network nodes etc. are provided herein for addressing one or more of the issues indicated above.

A first aspect provides embodiments of a method at a first wireless communication device (WCD). The method comprises transmitting a first indication to a second WCD or receiving a first indication from a second WCD. The first indication indicates a first time period during which the first WCD is expected to monitor for receipt of a transmission. The method comprises monitoring for receipt of a transmission during the first time period. The first WCD is not expected to monitor for receipt of a transmission during a second time period before the first time period begins. The transmitting or receiving of the first indication is performed after a link has been established between the first WCD and the second WCD for relaying of information to and/or from a network via one or more sidelink transmissions between the first WCD and the second WCD.

A second aspect provides embodiments of a first WCD. The first WCD is configured to transmit a first indication to a second WCD or receive a first indication from a second WCD. The first indication indicates a first time period during which the first WCD is expected to monitor for receipt of a transmission. The first WCD is configured to monitor for receipt of a transmission during the first time period. The first WCD is not expected to monitor for receipt of a transmission during a second time period before the first time period begins. The first WCD is configured to perform the transmission or receipt of the first indication after a link has been established between the first WCD and the second WCD for relaying of information to and/or from a network via one or more sidelink transmissions between the first WCD and the second WCD.

The first WCD may for example comprise processing circuitry configured to cause the first WCD to transmit or receive the first indication, and to monitor for receipt of a transmission during the first time period.

A third aspect provides embodiments of a method at a second WCD. The method comprises transmitting a first indication to a first WCD or receiving a first indication from a first WCD. The first indication indicates a first time period during which the first WCD is expected to monitor for receipt of a transmission. The method comprises transmitting to the first WCD during the first time period. The first WCD is not expected to monitor for receipt of a transmission during a second time period before the first time period begins. The transmitting or receiving of the first indication is performed after a link has been established between the first WCD and the second WCD for relaying of information to and/or from a network via one or more sidelink transmissions between the first WCD and the second WCD.

A fourth aspect provides embodiments of a second WCD. The second WCD is configured to transmit a first indication to a first WCD or receive a first indication from a first WCD. The first indication indicates a first time period during which the first WCD is expected to monitor for receipt of a transmission. The second WCD is configured to transmit to the first WCD during the first time period. The first WCD is not expected to monitor for receipt of a transmission during a second time period before the first time period begins. The second WCD is configured to perform the transmission or receipt of the first indication after a link has been established between the first WCD and the second WCD for relaying of information to and/or from a network via one or more sidelink transmissions between the first WCD and the second WCD.

The second WCD may for example comprise processing circuitry configured to cause the second WCD to transmit or receive the first indication, and to transmit to the first WCD during the first time period.

### BRIEF DESCRIPTION OF THE DRAWINGS

In what follows, example embodiments will be described in greater detail with reference to the accompanying drawings, on which:

FIG. 1a shows the NR-SL user plane protocol stack;

FIG. 1b shows the NR-SL control plane protocol stack;

FIG. 2 shows a unicast link connection establishment procedure;

FIG. 3 shows an example scenario for NR-SL resource sensing;

FIG. 4 illustrates a relaying situation involving a remote WCD and a relay WCD, according to some embodiments;

FIG. 5 illustrates active and inactive periods of a WCD, according to some embodiments;

FIG. 6 is a flow chart of a method at a first WCD, according to some embodiments;

FIG. 7 is a flow chart of a method at a second WCD, according to some embodiments;

FIG. 8 shows the method from FIG. 6, but with optional extra steps, according to some embodiments;

FIG. 9 shows the method from FIG. 6, but with optional extra steps, according to some embodiments;

FIG. 10 shows the method from FIG. 7, but with an optional extra step, according to some embodiments;

FIG. 11 shows the method from FIG. 6, but with optional extra steps, according to some embodiments;

FIG. 12 shows the method from FIG. 7, but with optional extra steps, according to some embodiments;

FIG. 13 illustrates coordination regarding a reception pattern of a remote WCD, according to some embodiments;

FIG. 14 illustrates an offset between a reception pattern of a relay WCD and a reception patterns of a remote WCD, according to some embodiments;

FIG. 15 illustrates coordination regarding a reception pattern of a relay WCD, according to some embodiments;

FIG. 16 shows the method from FIG. 6, but with optional extra steps, according to some embodiments;

FIG. 17 shows the method from FIG. 7, but with an optional extra step, according to some embodiments;

FIG. 18 shows the method from FIG. 6, but with optional extra steps, according to some embodiments;

FIG. 19 shows the method from FIG. 7, but with optional extra steps, according to some embodiments;

FIG. 20 shows the method from FIG. 6, but with optional extra steps, according to some embodiments;

FIG. 21 shows the method from FIG. 7, but with optional extra steps, according to some embodiments;

FIG. 22 shows first and second WCDs communicating with each other, according to some embodiments;

FIG. 23 is a flow chart of a method at the first WCD in FIG. 22, according to some embodiments;

FIG. 24 is a flow chart of a method at the second WCD in FIG. 22, according to some embodiments;

FIG. 25 is a flow chart of a method at a first WCD, according to some embodiments;

FIG. 26 illustrates an example of a communications network in which embodiments of the present disclosure may be implemented;

FIG. 27 is a schematic block diagram of a WCD, according to some embodiments;

FIG. 28 is a schematic block diagram of a network node, according to some embodiments; and

FIG. 29 is a schematic block diagram that illustrates a virtualized embodiment of a network node, according to some embodiments.

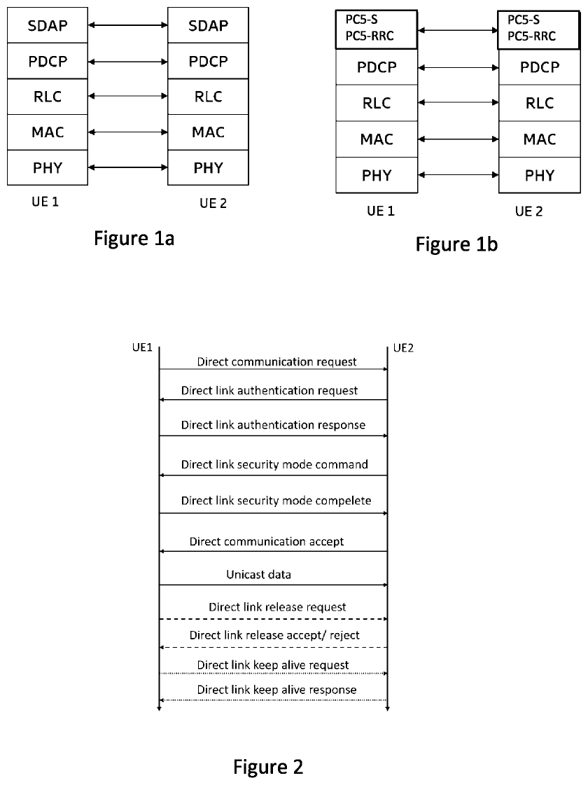

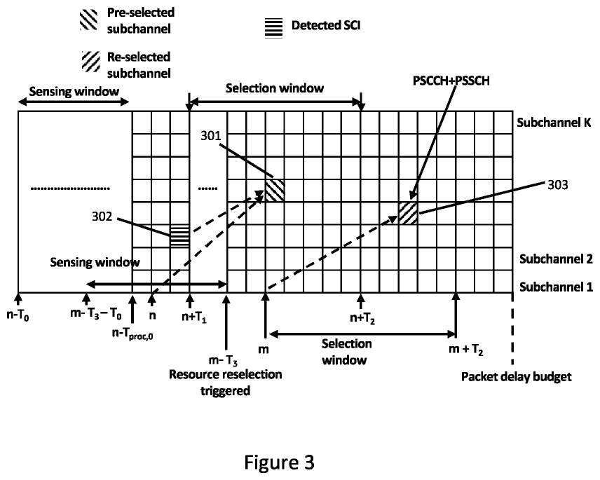

All the figures are schematic, not necessarily to scale, and generally only show parts which are necessary in order to elucidate the respective embodiments, whereas other parts may be omitted or merely suggested. Any reference number appearing in multiple drawings refers to the same object or feature throughout the drawings, unless otherwise indicated. Even if flow charts for methods performed by cooperating first and second WCDs are shown side by side, the positions of the method steps shown in the respective flow charts have not been selected to reflect the timing of the method steps performed by the first WCD relative to the timing of method steps performed by the second WCD. In the flow charts, dashed boxes represent optional method steps.

### DETAILED DESCRIPTION

Some of the embodiments contemplated herein will now be described more fully with reference to the accompanying drawings. Other embodiments, however, are contained within the scope of the subject-matter disclosed herein. The scope of the present disclosure should not be construed as limited to only the embodiments set forth herein. Rather, these embodiments are provided by way of example to convey the scope of the disclosed subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. It will be appreciated that the word “comprising” does not exclude other elements or steps. The word “or” is not to be interpreted as an exclusive or (sometimes referred to as “XOR”). On the contrary, expressions such as “A or B” covers all the cases “A and not B”, “B and not A” and “A and B”. The mere fact that certain measures are recited in mutually different dependent claims or embodiments does not indicate that a combination of these measures cannot be used to advantage. Any feature of any of the embodiments or claims disclosed herein may be applied to any other embodiment or claim, wherever appropriate. Likewise, any advantage of any of the embodiments or claims may apply to any other embodiments or claims, and vice versa. Other objectives, features and advantages of the enclosed embodiments will be apparent from the following description.

### Overview

UE based sidelink (SL) relaying is an interesting option for supporting extended coverage in a NR network, without compromising the UE power efficiency. It's therefore an interesting option for enabling NR support for massive IoT use cases. The existing NR-SL interface and protocol (which were described above in the background section) could be adapted/modified to support relay functionality. The NR-SL is designed for V2X applications whose traffic characteristics are different from massive IoT use cases. Hence, the current NR-SL may not be optimal for supporting battery operated, low data rate IoT devices. The present disclosure provides several approaches for how to save power in a relaying scenario for IoT devices. Since at least some IoT devices may have very limited battery capacity, power consumption may be an important aspect to consider when designing relaying solutions for IoT devices.

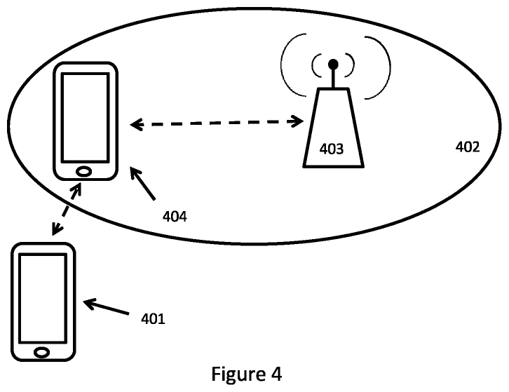

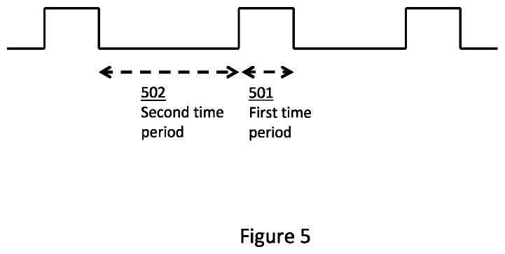

FIG. 4 illustrates a relaying situation, where a wireless communication device (WCD) 401 is located outside a coverage area 402 of a network node 403. The WCD 401 is referred to herein as a remote WCD 401. Another WCD 404 is located within the coverage area 402 of the network node 403 and is also within range of the remote WCD 401. That other WCD 404 may therefore act as a relay for information between the remote WCD 401 and the network node 403, and is referred to herein as a relay WCD 404. In other words, information from the network node 403 may be relayed to the remote WCD 401 via the relay WCD 404, and information from the remote WCD 401 may be relayed to the network node 403 via the relay WCD 404. The remote WCD 401 is sometimes referred to herein as a remote UE. The relay WCD 404 is sometimes referred to herein as a relay UE. The relay WCD 404 may for example have a PC-5 interface towards the remote WCD 401 and a Uu interface towards the network node 403. Transmissions between the remote WCD 401 and the relay WCD 404 are referred to herein as sidelink transmissions, while transmissions from the network node 403 to the relay WCD 404 are referred to as downlink transmissions, and transmissions from the relay WCD 404 to the network node 403 are referred to as uplink transmissions. Even if the remote WCD 401 shown in FIG. 4 is out of coverage of the network node 403, it will be appreciated that the relay WCD 404 could still act as a relay between the remote WCD 401 and the network node 403 if the remote WCD 401 is within coverage of the network node 403. In other words, the term “remote WCD” or “remote UE” does not require the WCD or UE to be out of coverage of the network node 403. Instead, the term “remote WCD” describes the role of the WCD 401 in relation to the relay WCD 404 in a relaying scenario. Hence, the remote WCD 401 could in some scenarios also receive direct downlink transmissions from the network node 403 and/or transmit direct uplink transmissions to the network node 403 (without having to always communicate with the network node via the relay WCD 404).

The remote WCD 401 and the relay WCD 404 are both illustrated in FIG. 4 as smart phones, but it will be appreciated that these two WCDs may for example be of different types. The remote WCD 401 and the relay WCD 404 may be any type of device that is able to communicate wirelessly, for example with a wireless communication network (such as a cellular network). Some examples of a WCD include, but are not limited to, a User Equipment (UE) in a 3GPP network, a Machine Type Communication (MTC) device, and an Internet of Things (IoT) device. The WCD may for example be (or may for example be integrated into) a mobile phone, smart phone, sensor device, meter, vehicle, household appliance, medical appliance, media player, camera, or any type of consumer electronic device, for instance, but not limited to, a television, radio, lighting arrangement, tablet computer, laptop, or personal computer (PC). The WCD may for example be a portable, hand-held, computer-comprised, or vehicle-mounted mobile device, enabled to communicate voice and/or data via a wireless connection. The remote WCD 401 may for example be an IoT device with limited power supply, while the relay WCD 404 may not necessarily have the same need to save power as the remote WCD 401.

The network node 403 may be any node in a communication network that is able to communicate wirelessly with a WCD, such as a node in a Radio Access Network (RAN) of a cellular communications network that operates to wirelessly transmit and/or receive signals. Some examples of a network node include, but are not limited to, a base station (for example a gNB (or gNodeB) in a 3GPP Fifth Generation (5G) NR network or an enhanced or evolved Node B (eNB) in a 3GPP LTE network), a high-power or macro base station, a low-power base station (for example a micro base station, a pico base station, a home eNB, or the like), a relay node, a network node that implements part of the functionality of a base station (for example a network node that implements a gNB Central Unit (gNB-CU) or a network node that implements a gNB Distributed Unit (gNB-DU)) or a network node that implements part of the functionality of some other type of node in a RAN.

### Power Saving Mode (PSM) and Discontinuous Reception (DRX)

PSM is a solution adopted by LTE-M (LTE machine type communication) and NB-loT (narrowband IoT) for aggressively conserving device energy. Operating in the PSM state, a WCD can shut down its transceiver and only keeps a real-time clock running for the sake of time keeping. Before entering the PSM state, the WCD and the network agree to one or more timers. The WCD wakes from PSM and turns on its transceiver for a tracking-area update (TAU) once the periodic TAU timer expires, or at any point in time for mobile originated (MO) data transmission. The WCD can also be reachable for downlink transmissions during a short time period after the WCD finishes its TAU transmission. The short time period during which the WCD is reachable is according to another timer. During the PSM state, the network retains state information associated with the WCD and the WCD remains registered with the network. A similar feature known as MICO (mobile initiated communication only) can be employed in NR. The timer used in NR for controlling when the UE is to wake up is referred to as a periodic registration timer (T₃₅₁₂).

In some embodiments, the Uu (radio interface between the radio access network and the WCD) PSM operation is adapted for sidelink operation between a relay WCD 404 and a remote WCD 401. The remote WCD 401 will then only wake up from PSM to transmit data (and possibly for TAU), after which there will be a short window during which the remote WCD 401 will monitor for incoming transmissions. After this time window, the remote WCD 401 may return to the PSM state to save power. When the remote WCD 401 is in PSM, it may shut down its transceiver (and optionally also one or more other parts/components of the remote WCD 401) and not monitor for incoming transmissions. The relay WCD 404 and the remote WCD 401 may agree to one or more timers, based on which the remote WCD 401 determines when to enter and exit the SL PSM state. For example, one longer timer could be used for the remote WCD 401 to periodically become available to check for incoming transmissions (the length of this timer is determined by the requirements on DL latency), and another shorter timer could be used to control the length of the window during which the remote WCD 401 is available. During the SL PSM state, the relay WCD 404 maintains the state information and UE context associated with the remote WCD 401. DRX could also be employed to save power. In legacy operation, DRX is a configured interval in terms of system (radio) frame number at which the WCD wakes up to monitor paging. In an alternative to the SL PSM embodiments described above, DRX can be configured for the remote WCD 401 based on a timer. This may be useful if the remote WCD 401 is battery operated and needs to conserve energy. Extended DRX (eDRX) could also be used for extending the time during which the remote WCD 401 may keep its receiver inactive. The relay WCD 404 and remote WCD 401 may agree to a timer (the “DRX cycle length”), based on which the remote WCD 401 determines when to wake up from a sleep state and activate its receiver to be able to decode incoming transmissions. Alternatively, the “DRX cycle length” can be based on a number of slots. In both cases a common reference time to is defined (for example during the configuration), at which time the timer is started or at which time the slots start to be counted. A second timer or a second number of slots can be configured to control the length of the on-duration (that is, how long the remote WCD 401 will monitor for incoming transmission upon each wake-up). During the DRX operation, the relay WCD 404 maintains the state information and UE context associated with the remote WCD 401.

The ideas presented above for PSM and DRX will be described more generally below with reference to FIGS. 5-7.

FIG. 5 illustrates active and inactive periods of a WCD, according to some embodiments. In particular, FIG. 5 shows an active period 501 in which the receiver of the WCD is active, and an inactive period 502 in which the receiver of the WCD may be inactive to save power. The active period 501 will sometimes be referred to herein as a first time period and as an on-period. The inactive period 502 will sometimes be referred to herein as a second time period and as an off-period. It will be appreciated that the relative sizes of the active period 501 and the inactive period 502 do not necessarily reflect realistic durations. For example, the inactive period 501 is often many times as long as the active period 503.

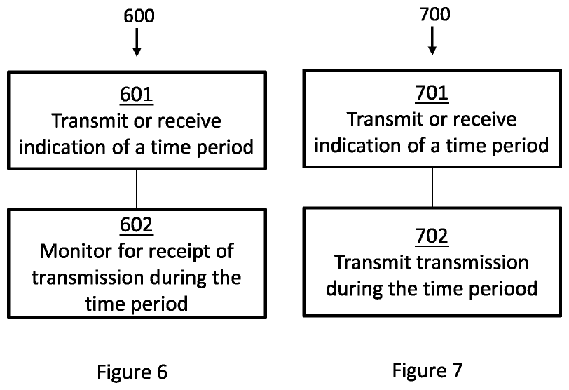

FIG. 6 is a flow chart of a method 600 at a first WCD, according to some embodiments. The method 600 may for example be performed by the first WCD, or by one or more parts/portions/components of the first WCD. The first WCD may for example be the remote WCD 401 or the relay WCD 404.

The method 600 comprises transmitting a first indication to a second WCD or receiving a first indication from a second WCD. The transmission or receipt of the first indication is represented in FIG. 6 by the step 601. The first indication indicates a first time period during which the first WCD is expected to monitor for receipt of a transmission. The first time period is exemplified in FIG. 5 by the active period 501, so the reference number 501 will be employed herein for the first time period. If the first WCD is the remote WCD 401, then the second WCD may be the relay WCD 404. If the first WCD is the relay WCD 404, then the second WCD may be the remote WCD 401. When the first time period 501 is supposed to begin (and optionally also how long it is supposed to be) may for example be determined by the remote WCD 401, or the relay WCD 404, or the network node 403, or by some other part of the network to which the network node 403 belongs. Both of the WCDs need to be aware of the first time period 501 for a transmission to be successfully transmitted from the second WCD to the first WCD. The first indication transmitted or received at step 601 may for example explicitly indicate the first time period 501, for example by stating the beginning and duration of the first time period 501 (or the beginning and end of the first time period 501). Alternatively, the first indication may implicitly indicate the first time period 501, for example by indicating the start and/or duration of the first time period 501 relative to some other quantity, such as relative to a start/end/duration of an earlier time period. The first indication may for example be transmitted/received via a message, or via some other type of signaling.

The method 600 comprises monitoring 602 for receipt of a transmission during the first time period 501. The monitoring 602 may for example include keeping a receiver of the first WCD active (or powered on, or enabled), to be able to receive a transmission from the second WCD or from a network node. The first WCD may for example receive one or more transmission from the second WCD during the first time period.

The transmitting or receiving of the first indication at step 601 is performed after a link has been established between the first WCD and the second WCD for relaying of information to and/or from a network via one or more sidelink transmissions between the first WCD and the second WCD. If the first WCD is the remote WCD 401 and the second WCD is the relay WCD 404, the link may for example allow information from the first WCD to be relayed by the second WCD to the network node 403 and/or information from the network node 403 to be relayed by the second WCD to the first WCD. If the first WCD is the relay WCD 404 and the second WCD is the remote WCD 401, the link may for example allow information from the second WCD to be relayed by the first WCD to the network node 403 and/or information from the network node 403 to be relayed by the first WCD to the second WCD. The link between the first and second WCD may for example be established via the link establishment procedure described above in the background section with reference to FIG. 2. The link may for example be a NR-SL link. Establishing the link may for example comprise transmitting or receiving one or more of the following messages: a direct communication request, a direct link authentication request, direct link authentication response, a direct link security mode command message, a direct link security mode complete message, a direct communication accept message, a direct link keep alive request, or direct link keep alive response.

In the method 600, the first WCD may for example not expected to (or required to, or mandated to) monitor for receipt of a transmission during a second time period before the first time period begins. The second time period is exemplified in FIG. 5 by the inactive period 502, so the reference number 502 will be used herein for the second time period 502.

The second time period 502 may for example begin after the transmission/receipt 601 of the first indication and may for example end before (or at the same time as) the first time period 501 begins. However, the second time period 502 could also begin already before the step 601 if the step 601 consists of a transmission from the first WCD to the second WCD of the first indication, because then there is no need for the receiver of the first WCD to be active during the step 601. The second time period 502 may for example be longer than the first time period 501. The second time period 502 may for example be at least a factor 5, or 10, or 100, or 1000, or 10000 times as long as the first time period 501. This allows the first WCD to save power, which may be particularly useful if the first WCD is an IoT device with limited battery resources. It will be appreciated that even if the first WCD is not expected to (or required to, or mandated to) to monitor for receipt of a transmission during the second time period 502, the first WCD may not be forbidden to monitor for a transmission during the second time period 502. Hence, the first WCD could for example monitor for a transmission also during the second time period 502.

According to some embodiments, a receiver of the first WCD may be inactive (or switched off, or powered down) during at least a portion of the second time period 502 (or during the entire second time period 502). One or more additional components (or parts of) the first WCD may also be inactive (or switched off, or powered down) during that time period, such as a transmitter of the first WCD. More of less the entire first WCD may for example be inactive during the second time period, except for means necessary to keep track of when the first WCD is supposed to wake up for monitoring during the first time period 501. A receiver of the first WCD may for example be inactive (or switched off, or powered down) from the transmission/receipt 601 of the first indication until the first time period 501 begins. In other words, the receiver of the first WCD may be switched off after the transmission/receipt 601 of the first indication, and may be kept off until the first time period 501 begins.

The second time period 502 (which can also be referred to as an off-period or off-duration) may typically be longer than the first time period 501 (which can also be referred to as an off-period or off-duration). The default value for the timer T₃₅₁₂ in MICO is 54 minutes, but the corresponding timer for PSM can be configured all the way up to 14 days. Regarding DRX, legacy values for the off-period durations are up to 2.56 seconds. However, there are ongoing discussions for NR release 17 regarding extended DRX (eDRX) cycles including 10.24 seconds and even up to 10485.76 seconds. Unlike MICO/PSM, the DRX off-duration is typically configured in numbers of radio frames, so the value 10485.76 seconds corresponds to 2\hat{ }20 radio frames (that is, 2\hat{ }20*10 ms). DRX values are therefore typically limited to even number of radio frames, such as 2\hat{ }N. Hence, the second time period 502 may for example be at least 1 seconds, or at least 10 seconds, or at least 1 minute, or at least one hour, or at least one day, or at least one week, or at least one month, or at least one year. The first time period 501 may for example be at most 1 ms, or at most 10 ms, or at most 1 s, or at most 10 s, or at most 1 minute. The first time period 501 may for example begin at least this long after the transmission 601 or receipt 601 of the first indication:
one minute; or
one hour; or
one day; or
one week; or
one month; or
one year.

A beginning of the first time period 501 (or a length/duration of the second time period 502) may for example be determined based on a latency requirement of the first WCD and/or of the second WCD. For example, if the first WCD is the relay WCD 404, then a strict/tough DL latency requirement for the first WCD may lead to use of a short second time period 502.

FIG. 7 is a flow chart of a method 700 at the second WCD, according to some embodiments. The method 700 may for example be performed by the second WCD, or by one or more parts/portions/components of the second WCD, while the method 600 is performed at the first WCD.

The method 700 comprises transmitting the first indication to the first WCD or receiving the first indication from the first WCD. The transmission or receipt of the first indication is represented in FIG. 7 by the step 701. As described above for the method 600, the first indication indicates a first time period 501 during which the first WCD is expected to monitor for receipt of a transmission. If the first indication is transmitted at step 601 in the method 600, then it is received at step 701. If the first indication is transmitted at step 701, then it is received at step 601 in the method 600.

The method 700 comprises transmitting 702 to the first WCD during the first time period. The step 702 may for example include transmitting one or more transmissions to the first WCD, for example in the form of one or more messages, or some other type of signaling. The transmission 702 to the first WCD may for example be specifically adapted for receipt by the second WCD, or may be suitable for receipt by multiple WCDs and/or also one or more network nodes.

The transmitting or receiving of the first indication at step 701 is performed after a link has been established between the first WCD and the second WCD for relaying of information to and/or from a network via one or more sidelink transmissions between the first WCD and the second WCD. If the first WCD is the remote WCD 401 and the second WCD is the relay WCD 404, the link may for example allow information from the first WCD to be relayed by the second WCD to the network node 403 and/or information from the network node 403 to be relayed by the second WCD to the first WCD. If the first WCD is the relay WCD 404 and the second WCD is the remote WCD 401, the link may for example allow information from the second WCD to be relayed by the first WCD to the network node 403 and/or information from the network node 403 to be relayed by the first WCD to the second WCD. The link between the first and second WCD may for example be established via the link establishment procedure described above in the background section with reference to FIG. 2. The link may for example be a NR-SL link. Establishing the link may for example comprise transmitting or receiving one or more of the following messages: a direct communication request, a direct link authentication request, direct link authentication response, a direct link security mode command message, a direct link security mode complete message, a direct communication accept message, a direct link keep alive request, or direct link keep alive response.

As described above for the method 600, the first WCD may for example not be expected to (or required to, or mandated to) monitor for receipt of a transmission during a second time period 502 before the first time period 501 begins. A receiver of the first WCD may for example be inactive (or switched off, or powered down) during at least a portion of the second time period 502 (or during the entire second time period 502).

Information about the first time period 501 may for example be obtained from the network. If both WCDs are within range of the network, such as in the coverage area 402 of the network node 403, then the network may signal the first time period 501 directly to both WCDs. However, if one of the WCDs is out of coverage, then information about the first time period 501 may be signaled by the network to the relay WCD 404 and the relay WCD 404 may forward this information to the remote WCD 401. Hence, the method 600 may for example comprise:
receiving a second indication from the network, wherein the second indication indicates the first time period 501; and
transmitting 601 the first indication to the second WCD.

Alternatively or additionally, the method 700 may for example comprise:
receiving a second indication from the network, wherein the second indication indicates the first time period 501; and
transmitting 701 the first indication to the first WCD.

According to some embodiments, the first indication referred to at steps 601 and 701 may indicate a first timer value controlling a beginning of the first time period 501 and/or a second timer value controlling a duration of the first time period 501. The timer controlling the beginning of the first time period 501 may for example be a periodic tracking area update timer (T₃₄₁₂) as in PSM, or a periodic registration timer (T₃₅₁₂) as in MICO. The timer controlling the duration of the first time period 501 may for example be an active timer (T₃₃₂₄) that could also be used in PSM or MICO.

According to some embodiments, the first WCD employs a periodic registration timer (such as T₃₅₁₂) for communication with a network node 403 of the network. The first time period 501 may for example be coordinated with the periodic registration timer. The first time period 501 may for example begin when the periodic registration timer expires. An active period (or on-period) used by the first WCD to communicate directly with the network may for example also be employed by the first WCD for communicating with the second WCD. The active period may coincide with (or at least partially overlap) the first time period 501. If the first WCD is the relay WCD 404, the periodic registration timer may be employed by the first WCD to communicate directly with the network node 403. The remote WCD 401 may not be in range to communicate directly with the network node 403, but may still use a periodic registration timer to wake up regularly, so that transmissions form the network node 403 (or some other node in the network) may be received if the remote WCD 401 gets within coverage. Hence, if the first WCD is the remote WCD 401, the periodic registration timer may be employed by the first WCD 401 to communicate directly with the network node 403 when the remote WCD 401 is within range of the network node 403. The relay WCD 404 may for example employ the same PSM active period for communicating with the network node 403 as for communicating with the remote WCD 401. The remote WCD 401 may for example employ the same PSM active period for communicating with the network node 403 as for communicating with the relay WCD 404.

According to some embodiments, the first WCD employs a discontinuous reception (DRX) cycle for communication with a network node of the network. The first time period 501 may for example be coordinated with the DRX cycle. The first time period 501 may for example be coordinated with a DRX cycle length of the DRX cycle and/or with a DRX on-duration of the DRX cycle. The first time period 501 may for example coincide with (or at least partially overlap) an on-period of the DRX cycle. It will be appreciated that the DRX cycle referred to herein may for example be a so-called extended DRX (eDRX) cycle, where the inactive period may be considerably longer than for ordinary DRX. The DRX cycle may for example include that the first WCD monitors paging during at least a portion of the first time period. A DRX active period (or on-period, or on-duration) used by the first WCD to communicate directly with the network may for example also be employed by the first WCD for communicating with the second WCD. The DRX active period may for example coincide with (or at least partially overlap) the first time period 501. If the first WCD is the relay WCD 404, the DRX cycle may be employed by the first WCD 401 to communicate directly with the network node 403. The remote WCD 401 may not be in range to communicate directly with the network node 403, but may still use a DRX cycle to wake up regularly, so that transmissions form the network node 403 (or some other node in the network) may be received if the remote WCD 401 gets within coverage. Hence, if the first WCD is the remote WCD 401, the DRX cycle may be employed by the first WCD 401 to communicate directly with the network node 403 when the remote WCD 401 is within range of the network node 403. The relay WCD 404 may for example employ the same DRX active period for communicating with the network node 403 as for communicating with the remote WCD 401. The remote WCD 401 may for example employ the same DRX active period for communicating with the network node 403 as for communicating with the relay WCD 404. The start of the DRX active period may for example be based on a system frame number (SFN), which may for example be broadcasted by the relay WCD 404 in case the remote WCD 401 is out of coverage of the network node 403 (or is out of coverage of the network).

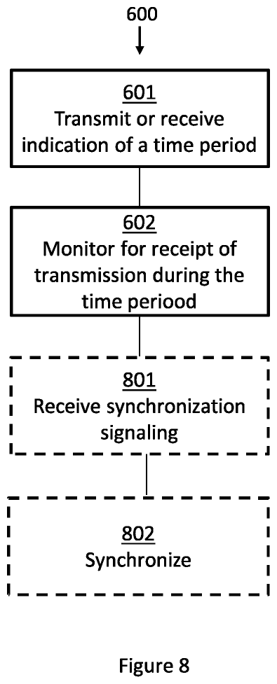

According to some embodiments, the first WCD is the remote WCD 401 and the second WCD is the relay WCD 404. The link between the first WCD 401 and the second WCD 404 is therefore configured for relaying of information from the first WCD 401 to the network via one or more sidelink transmissions from the first WCD 401 to the second WCD 404. The relay WCD 404 may for example start transmitting a SL synchronization signal during (or slightly before) the first time period 501. This is to assist the remote WCD 401 to establish synchronization with the relay WCD 404. Hence, in the method 700, the transmission(s) transmitted at step 702 may optionally include synchronization signaling. Also, as shows in FIG. 8, the method 600 from FIG. 6 may optionally comprise
receiving 801 the synchronization signaling from the second WCD 404 during the monitoring 602; and
synchronizing 802 with the second WCD 404 based on the synchronization signaling.

The synchronization signaling may for example indicate a system frame number (SFN). The SFN may for example be employed for synchronizing DRX cycles between the first WCD and the second WCD.

In case of PSM (or MICO), the relay WCD 404 (the second WCD in this embodiment) may for example start transmitting 702 the synchronization signaling when (or slightly before) the agreed PSM (or MICO) timer(s) expire, so that the remote WCD 401 (the first WCD in this embodiment) can receive 801 the synchronization signaling while the receiver of the remote WCD 401 is active. If the relay WCD 404 communicates with more than one remote WCD 401, the relay WCD 404 may for example set the PSM timers (or MICO timers) of the remote WCDs so that the relay WCD 404 can broadcast the synchronization signaling to more than one remote WCD at the same time.

In case of DRX, the relay WCD 404 (the second WCD in this embodiment) may for example start transmitting the synchronization signaling when (or slightly before) the agreed DRX on-period (or on-duration), so that the remote WCD 401 (the first WCD in this embodiment) can receive the synchronization signaling while the receiver of the remote WCD 401 is active. If the relay WCD 404 communicates with more than one remote WCD 401, the relay WCD 404 may for example set the DRX on-periods so that it can broadcast the synchronization signaling to more than one remote WCD 401 at the same time.

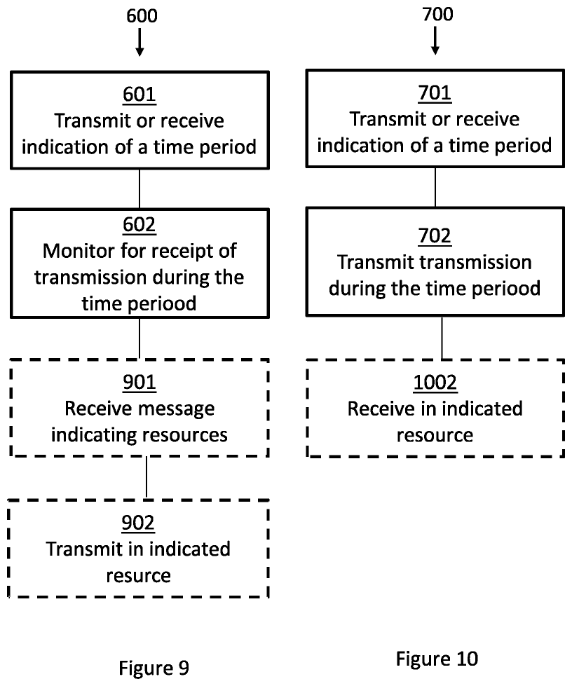

According to some embodiments, the relay WCD 404 may include certain sidelink broadcast or control information in a broadcast channel. For example, the broadcast channel may indicate an updated radio resource pool for the remote WCD 401 to use. The remote WCD 401 may for example transmit its data after establishing synchronization and acquiring updated information about sidelink radio resources. Hence, in the method 700, the transmission(s) transmitted at step 702 may for example include a message transmitted for receipt by multiple WCDs. The message may for example indicate a collection of resources available for transmission to the relay WCD 404 (the second WCD in this embodiment). Also, as shown in FIG. 9, the method 600 from FIG. 6 may comprise the optional steps of
receiving 901, during the monitoring 602, the message transmitted by the second WCD 404 at step 702 for receipt by multiple WCDs, wherein the message indicates a collection of resources available for transmission to the relay WCD 404; and
transmitting 902 to the second WCD 404 in one or more resources from the collection of resources.

Further, as shown in FIG. 10, the method 700 from FIG. 7 may comprise the optional step of
receiving 1002 a transmission (for example transmitted at step 902) from the remote WCD 401 in one or more resources from the collection of resources.

The resources referred to in steps 901 and 902 may for example be time and frequency resources, such as resource elements in OFDM symbols or subframes in the time domain and in resource blocks or subcarriers in the frequency domain.

Alternatively or additionally, the transmission(s) transmitted at step 702 and received at step 901 may include a message transmitted for receipt by multiple WCDs, where the message indicates a timer value, and/or a timer restart condition, and/or a DRX parameter. The remote WCD 404 (the second WCD in this embodiment) may for example employ such information to make sure on-periods of the remote WCD 401 (the first WCD in this embodiment) are synchronized with on-periods of the relay WCD 404.

According to some embodiments, the first WCD is the relay WCD 404 and the second WCD is the remote WCD 401. The link between the first WCD and the second WCD is therefore configured for relaying of information from the second WCD to the network via one or more sidelink transmissions from the second WCD to the first WCD.

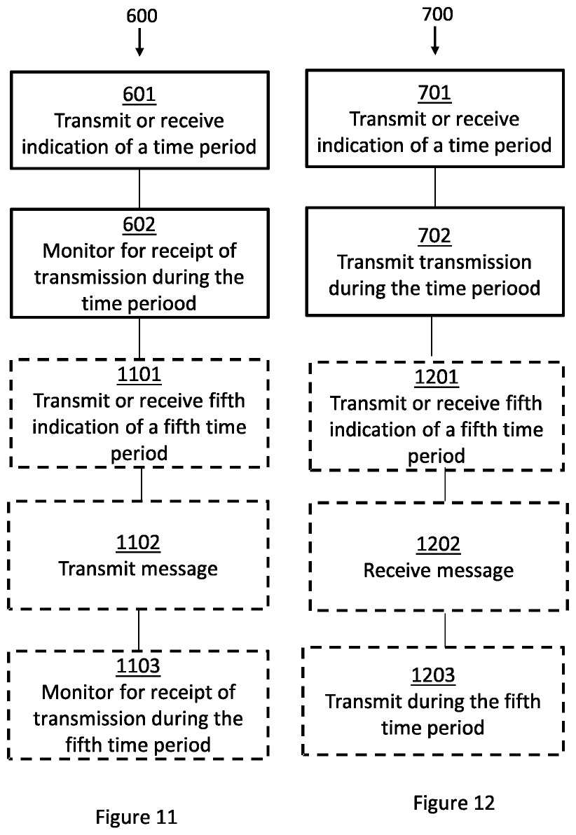

According to some embodiments, the relay WCD 404 and the remote WCD 401 may agree to a time period during which the remote WCD 401 will stay on and be reachable after a transmission, so that the relay WCD 404 may relay any downlink information to the remote WCD 401. Alternatively, or additionally, the relay WCD 404 and the remote WCD 401 may agree to a time interval during which the relay WCD 401 will stay on and be reachable after a transmission, so that the relay WCD 404 may receive information from the remote WCD 401 and relay that information to the network node 403. Hence, as shown in FIG. 11, the method 600 from FIG. 6 may optionally comprise
transmitting 1101 a fifth indication to the second WCD or receiving 1101 a fifth indication from the second WCD, wherein the fifth indication indicates a fifth time period during which the first WCD is expected to monitor for receipt of a transmission after transmitting a message to the second WCD;
transmitting 1102 a message to the second WCD; and
monitoring 1103 for receipt of a transmission during the fifth time period after
transmitting the message to the second WCD.

Also, as shown in FIG. 12, the method 700 from FIG. 7 may optionally comprise
transmitting 1201 a fifth indication to the first WCD or receiving 1202 a fifth indication from the first WCD (where the fifth indication is the same indication as the one transmitted or received at the optional step 1101 in the method 600);
receiving 1202 a message from the first WCD (where the message is the same message as transmitted at the optional step 1102 in the method 700); and
transmitting 1203 to the first WCD during the fifth time period (where the fifth time period is the time period during which the first WCD monitors at the optional step 1103 of the method 700).

The fifth time period referred to in the steps 1101-1103 and 1201-1203 above may for example be controlled by an active timer T₃₃₂₄.

Sidelink (SL) PSM, as described above, can be coordinated between the macro network and the relay nodes. That is, in the macro network WCDs will wake up according to the periodic RAU timer, and the SL-PSM timer can therefore be coordinated with this timer to have consistent behavior independent of if the remote WCD 401 is connecting via a direct link or via a relay. If the relay WCD 404 is a WCD using PSM, the SL-PSM timer could be coordinated with the periodic RAU timer for the relay WCD 401 to have a predictable DL latency.

SL DRX, as described above, can also be coordinated between the macro network and the relay nodes. That is, in the macro network, WCDs will wake up according to the configured DRX cycle in Idle and Inactive states (see for example default paging cycle), and the DRX cycle length can therefore be coordinated between the macro network and the SL to have consistent, known and predictable WCD behavior, independent of if the remote WCD 401 is connecting via a direct link or via a relay. If the relay WCD 404 is using DRX, the SL DRX cycle length (or timer) could be coordinated with this DRX length to minimize the DL latency. If the remote WCD 401 is configured with a certain DRX or eDRX cycle, the SL DRX cycle length (or timer) could be coordinated with this DRX length to minimize the DL latency.

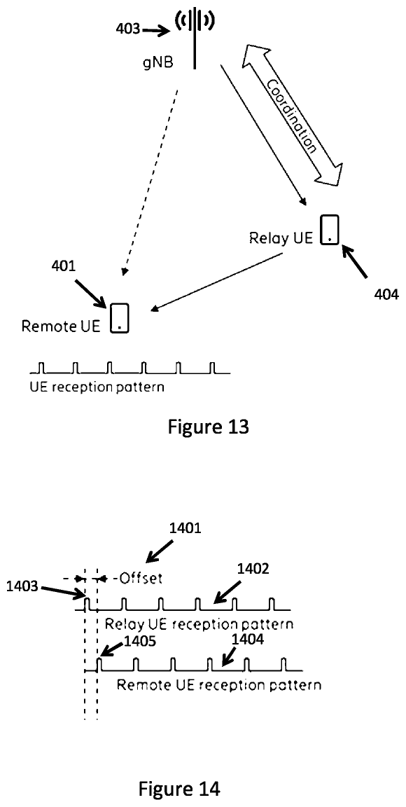

For downlink (DL) transmissions from the network node 403, a central thing is awareness of the reception pattern (such as PSM config or DRX) of the remote WCD 401. This is illustrated in FIG. 13. DRX (or eDRX) is configured by the core network (CN), and this configuration should be signalled to the relay WCD 404 (that is, in which radio frames and subframes the remote WCD 401 is receiving). For MICO, the associated timers ‘Periodic Registration Timer’ (T₃₅₁₂) and ‘Active Time’ (3324) are configured by the core network (similarly for PSM, but then with periodic TAU timer (T₃₄₁₂)). This configuration should be signalled to the relay WCD 404. In addition, compared to the DRX, the re-starting of the timer in PSM/MICO should also be coordinated between gNB/CN and relay WCD 404. That is, the timer T₃₅₁₂ is also restarted upon UL transmission, so if the remote WCD 401 transmits in UL directly to the gNB, the gNB informs this to the relay WCD 404 so that the relay WCD 404 can also restart T₃₅₁₂. Vice versa, if the remote WCD 401 transmits to the relay WCD 404, with layer 2 (L2) relaying to the network, the gNB/CN will be aware that the UL transmission comes from the remote WCD 401, so in this case it should be clear to both the relay WCD 404 and the gNB/CN to restart T₃₅₁₂. If the remote WCD 401 is out-of-coverage, and (e)DRX or MICO therefore needs to be configured by the relay WCD 404, there is no strict need for coordination unless the remote WCD 401 is expected to later be in coverage (in which case the already mentioned coordination applies). It would make sense to still have CN in charge of (e)DRX or MICO also over SL. In other words, the relay WCD 404 consults the CN when configuring (e)DRX or MICO, and even though the remote WCD 401 is signalled by the relay WCD 404, the CN is the controlling entity (such as routing the NAS signaling).

No matter if (e)DRX or MICO is configured by CN or the relay WCD 404, one could optimize DL latency by coordinating the DRX patterns to ensure that data/signaling can be forwarded to the remote WCD 401 shortly after it is received by the relay WCD 404 from the network. As illustrated in FIG. 14, this may for example be achieved by having an offset 1401 of the DRX pattern of the relay WCD 404 by a certain number of slots/subframes relative to the DRX pattern of the remote WCD 401. In the DRX patterns shown in FIG. 14, the valleys 1402 represent inactive periods (or off-periods) and the peaks 1403 represent the active periods (or on-periods) of the reception pattern of the relay WCD 404. Similarly, the valleys 1404 represent inactive periods (or off-periods) and the peaks 1405 represent the active periods (or on-periods) of the reception pattern of the remote WCD 401.

Note that the above coordination is primarily for layer 2 (L2) relaying, where the gNB 403 is aware that the remote WCD 401 is sitting “behind” the relay WCD 404. For L3 relaying, the gNB 403 is not aware of this, and needs to consider only the reception pattern of the relay WCD 404, which is covered by legacy procedures. However, in this case, the relay WCD 404 will need to configure DRX over the SL for the remote WCD 401, and it could be beneficial to have the same offset to reduce DL latency as shown in FIG. 14.

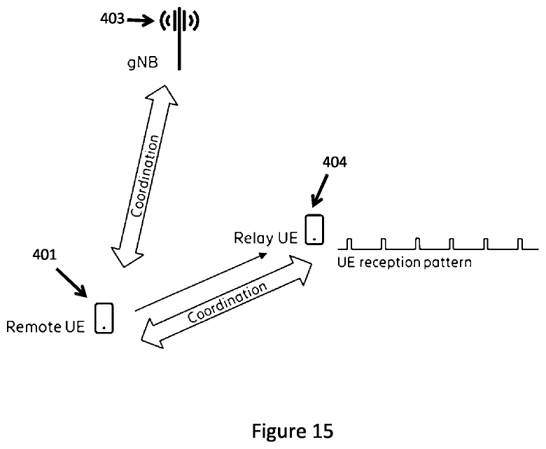

For uplink (UL) transmission to the network node 403, a central thing is that the remote WCD 401 is aware of the reception pattern (such as PSM config or DRX) of the relay WCD 404. This is illustrated in FIG. 15. For (e)DRX, the remote WCD 401 should be informed about the (e)DRX configuration of the relay WCD 404, either from the gNB or from the relay WCD 404 itself (for example as part of the SL relaying configuration). The latter solution (that is, to route the configuration via the relay WCD 404) is preferable, since the remote WCD 401 may be out of coverage of the gNB. For MICO, the remote WCD 401 should be informed about the relay WCD's associated timers ‘Periodic Registration Timer’ (T₃₅₁₂), and ‘Active Time’ (3324), and any re-starting of T₃₅₁₂. This can be signalled either from the gNB or the relay WCD 404. As above, the latter solution (that is, over relay SL) is preferable, since the remote WCD 401 may be out of coverage. For UL transmissions, the need for coordination should be the same regardless if the relay WCD 404 is a layer 2 (L2) relay or a layer 3 (L3) relay.

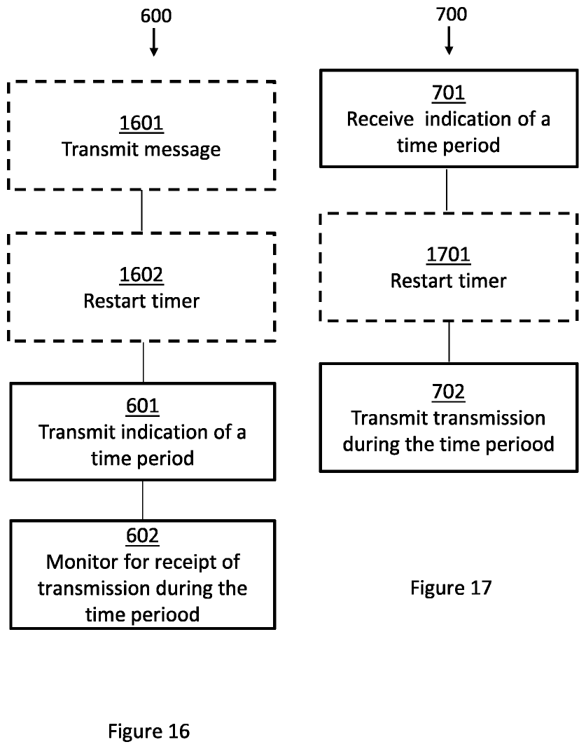

As described above, if the first WCD transmits in the UL and resets its timer, the second WCD should be informed about this, so that it can also reset its timer. In this way, both of the WCDs can keep track of the active period (or on-duration) begins. Hence, as shown in FIG. 16, the method 600 from FIG. 6 may comprise the optional steps of
transmitting 1601 a message to the network; and
restarting 1602 a timer that indicates a beginning of the first time period 501.

At step 601, the first indication is then transmitted 601 to the second WCD. The first indication may for example indicate to the second WCD that a message has been transmitted 1601 by the first WCD to the network and/or that a timer that indicates the beginning of the first time period 501 is restarted 1602. At step 701 in the method 700, the first indication is then received from the first WCD. As shown in FIG. 17, the method 700 from FIG. 7 may comprise the optional step of
restarting 1701 a timer indicating a beginning of the first time period 501.

The first indication may for example indicate transmission 1601 of a message by the first WCD to the network and/or that a timer that indicates the beginning of the first time period is restarted 1602.

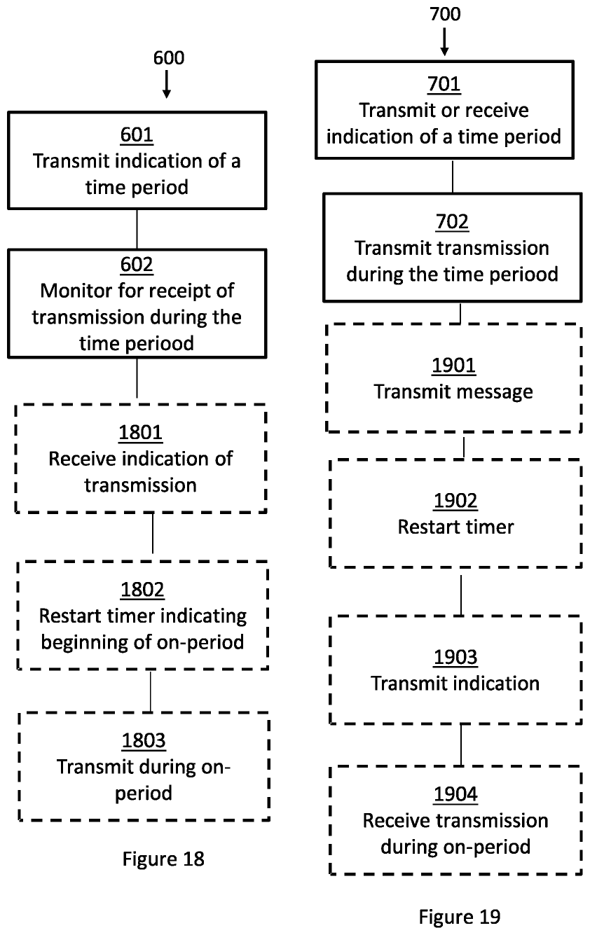

Similarly, if the second WCD transmits in the UL and resets its timer, the first WCD should be informed about this, so that it can reset its timer. Hence, as shown in FIG. 18, the method 600 from FIG. 6 may comprise the optional steps of
receiving 1801 a third indication from the second WCD or from the network, wherein the third indication indicates transmission of a message by the second WCD to the network; and
restarting 1802 a timer indicating a beginning of an on-period (or on-duration, active period) of the second WCD.

Here, the on-period of the second WCD means a time period during which the second WCD is expected to monitor for a transmission. A receiver of the second WCD may for example be active or powered on during the on-period of the second WCD. After restarting 1802 the timer indicating the beginning of the on-period of the second WCD, the method 600 may for example comprise the optional step of
transmitting 1803 a transmission to the second WCD during the on-period (or on-duration, or active period) of the second WCD.

As shown in FIG. 19, the method 700 from FIG. 7 may comprise the optional steps of
transmitting 1901 a message to the network;
restarting 1902 a timer that indicates the beginning of the on-period (or on-duration, or active period) of the second WCD, referred to at step 1802; and
transmitting 1903 the third indication to the first WCD, wherein the third indication indicates the beginning of the on-period (or on-duration, or active period) of the second WCD.

The third indication may for example indicate the transmission 1901 of the message to the network and/or the restarting 1902 of the timer. As shown in FIG. 19, the method 700 from FIG. 7 may for example comprise the optional step of
receiving 1904 a transmission from the first WCD during the on-period (or on-duration, or active period) of the second WCD.

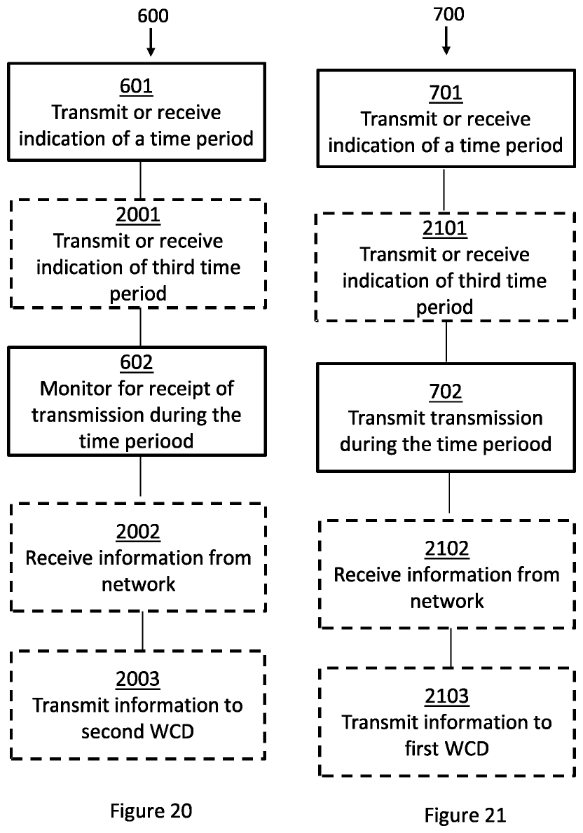

As described above with reference to FIG. 14, an offset 1401 may be provided between active periods 1403 of the relay WCD 404 and active periods 1405 of the remote WCD 401, so as to provide low DL latency. As shown in FIG. 20, the method 600 from FIG. 6 may include the optional step of
transmitting 2001 a fourth indication to the second WCD or receiving 2001 a fourth indication from the second WCD, wherein the fourth indication indicates a third time period during which the second WCD is expected to monitor for receipt of a transmission.

Also, as shown in FIG. 21, the method 700 from FIG. 7 may include the optional step of
transmitting 2101 the fourth indication to the first WCD or receiving 2101 the fourth indication from the first WCD, wherein the fourth indication indicates the third time period during which the second WCD is expected to monitor for receipt of a transmission.

In analogy with the first WCD's behavior during the first time period 501 described above with reference to FIG. 5, the second WCD may have its receiver active (or powered on) during the third time period so as to be able to receive one or more transmissions. The second WCD may for example not be expected to (or required to, on mandated to) monitor for receipt of a transmission during a fourth time period before the third time period begins. In analogy with the first WCD's behavior during the second time period 502 described above with reference to FIG. 5, the second WCD may for example have its receiver inactive (or powered off) during at least a portion of the fourth time period. A receiver of the second WCD may for example be inactive from the transmission or receipt of the fourth indication at step 2101 until the third time period begins. However, embodiments may also be envisaged in which a receiver of the second WCD is active (or powered on) during at least a portion of the time period from the transmission or receipt of the fourth indication at step 2101 until the third time period begins.

If the first WCD is the relay WCD 404 and the second WCD is the remote WCD 401, the first time period 501 from FIG. 5 corresponds to the active period 1403 of the relay WCD in FIG. 14, and the third period referred to at steps 2001 and 2101 corresponds to the active period 1405 of the remote WCD in FIG. 14. Hence, the first time period 1403 is located before the third time period 1405 due to an offset 1401. The method 600 may then optionally comprise
receiving 2002 information from the network during the first time 1403 period; and
transmitting 2003 the information to the second WCD during the third time period 1405.

Hence, the method 700 may comprise receiving information from the first WCD during the third time period 1405, where the information has been transmitted by the network during the first time period 1403. The offset 1401 may for example be defined as the time difference between the beginning of the first time period 1403 and the beginning of the third time period 1405. The second time period 502 in FIG. 5 corresponds to the off-periods 1402 of the relay WCD 404. The offset 1401 may for example be relatively short compared to the inactive periods 1402 of the relay WCD and/or the inactive periods 1404 of the remote WCD 401. Hence, the beginning of the first time period 1403 may for example precede the beginning of the third time period 1405 by no more than a fourth, or a tenth, or a hundredth of a duration of the second time period 1402. In other words, the offset 1401 may for example be no more than a fourth, or a tenth, or a hundredth of a duration of the inactive period 1402. The offset 1401 is intended to capture the processing delay in the relay WCD 404, which may for example include the time needed to receive and decode a packet and to re-package it to transmit. In LTE, 4 ms processing delay is a UE requirement, but NR devices are typically more capable than that. Hence, the offset 1401 may for example be between 1 milliseconds (ms) and 10 ms (which corresponds to 1-10 slots for with 15 kHz subcarriers-spacing). However, the offset 1401 could be below 1 ms, such as in the range 0.1 ms-1 ms.

The second WCD may for example employ a periodic registration timer (such as T₃₅₁₂) for communication with the network node 403. If the second WCD is the remote WCD 401, the third time period referred to at steps 2001 and 2101 may for example be coordinated with the periodic registration timer. The third time period may for example begin when the periodic registration timer expires.

The second WCD may for example employ a discontinuous reception (DRX) cycle for communication with the network node 403. If the second WCD is the remote WCD 401, the third time period referred to at steps 2001 and 2101 may for example be coordinated with the DRX cycle. The third time period may for example be coordinated with a DRX cycle length of the DRX cycle and/or with a DRX on-duration of the DRX cycle. The third time period may for example coincide with (or at least partially overlap) an on-period of the DRX cycle. It will be appreciated that the DRX cycle referred to herein may for example be a so-called extended DRX (eDRX) cycle, where the inactive period may be considerably longer than for ordinary DRX. The DRX cycle may for example include that the second WCD monitors paging during at least a portion of the third time period.

If, instead, the first WCD is the remote WCD 401 and the second WCD is the relay WCD 404, the first time period 501 from FIG. 5 corresponds to the active period 1405 of the relay WCD in FIG. 14, and the third period referred to at step 2001 corresponds to the active period 1403 of the remote WCD in FIG. 14. Hence, the third time period 1403 is located before the first time period 1405. As shown in FIG. 21, the method 700 from FIG. 7 may then comprise the optional steps of
receiving 2102 information from the network during the third time period 1403; and
transmitting 2103 the information to the first WCD during the first time period 1405.

The method 600 may then comprise receiving information from the second WCD during the first time period 1405, wherein the information has been transmitted by the network during the third time period 1403. The information has then been relayed by the second WCD from the network to the first WDC. In this scenario, the second time period 502 in FIG. 5 corresponds to the off-periods 1404 of the remote WCD 401. The offset 1401 may for example be relatively short compared to the inactive periods 1402 of the relay WCD 404 and/or the inactive periods 1404 of the remote WCD 401. Hence, the beginning of the third time period 1403 may for example precede the beginning of the first time period 1405 by no more than a fourth, or a tenth, or a hundredth of a duration of the second time period 1404. In other words, the offset 1401 may for example be no more than a fourth, or a tenth, or a hundredth of a duration of the inactive period 1404 of the remote WCD 404. Additionally or alternatively, the offset 1401 may for example be no more than a fourth, or a tenth, or a hundredth of a duration of the inactive period 1402 of the relay WCD 404. As described above, the offset 1401 may for example be between 1 milliseconds (ms) and 10 ms (which corresponds to 1-10 slots for with 15 kHz subcarriers-spacing). However, the offset 1401 could be below 1 ms, such as in the range 0.1 ms-1 ms.

The description provided above has been focused on the actions performed by the relay WCD 404 and the remote WCD 401 in FIG. 4. Example actions performed by the network node 403 in FIG. 4 in connection with some of the embodiments described above, will now be described.

In connection with the optional steps 2001-2003 in FIG. 20 performed by a first WCD or the optional steps 2101-2103 in FIG. 21 performed by a second WCD, information about the first and third time periods may be transmitted by the network node 403 to the relay WCD 404 to be forwarded by the relay WCD 404 to the remote WCD 401. In other words, the network node 403 may for example perform a method comprising
transmitting, to the relay WCD 404, one or more indications, wherein the one or more indications indicate a first time period during which the relay WCD 404 is expected to monitor for receipt of a transmission and a third time period during which the remote WCD 401 is expected to monitor for receipt of a transmission; and
transmitting to the relay WCD 404 in the first time period for relaying to the second WCD 401.

The relay WCD 404 may for example not expected to monitor for receipt of a transmission during a second time period before the first time period begins. The remote WCD 401 may for example not expected to monitor for receipt of a transmission during a fourth time period before the third time period begins.

The method performed by the network node 403 may for example comprise
receiving a message from the remote WCD 401 (such as the message transmitted at step 1901); and
transmitting a second indication to the relay WCD 404, the second indication indicating transmission of the message from the remote WCD 401 to the network node 403 (the second indication may for example be the second indication received at step 1801).

The second indication may for example indicate to the remote WCD 401 that a timer that indicates the beginning of the first time period 501 is restarted.

Alternatively or additionally, the method performed by the network node 403 may for example comprise
receiving a message from the relay WCD 404 (such as the message transmitted at step 1901); and
transmitting a second indication to the remote WCD 401, the second indication indicating transmission of the message from the relay WCD 404 to the network node 403 (the second indication may for example be the second indication received at step 1801).

The second indication may for example indicate to the relay WCD 404 that a timer that indicates the beginning of the first time period 501 is restarted.

Further embodiments of the first and second WCD, and of the methods performed at the first and second WCD, are defined in the claims. Further embodiments of the network node 403, and of methods performed by the network node 403, are provided in the following list of example embodiments (EE).

EE1. A method at a network node (403), the method comprising:
transmitting, to a first wireless communication device (401, 404), WCD, one or more indications, wherein the one or more indications indicate a first time period (501) during which the first WCD is expected to monitor for receipt of a transmission and a third time period during which a second WCD (401, 404) is expected to monitor for receipt of a transmission; and
transmitting to the first WCD in the first time period for relaying to the second WCD, wherein the first WCD is not expected to monitor for receipt of a transmission during a second time period (502) before the first time period begins.

EE2. The method of EE1, further comprising:
receiving a message from the second WCD; and
transmitting a second indication to the first WCD, the second indication indicating transmission of the message from the second WCD to the network node.

EE3. The method of EE2, wherein the second indication indicates to the first WCD that a timer that indicates the beginning of the third time period is restarted.

EE4. The method of any of EE1-EE3, wherein the first time period is located before the third time period.

EE5. The method of EE4, wherein a beginning of the first time period precedes a beginning of the third time period by no more than a tenth of a duration of the second time period.

EE6. The method of any of EE1-EE5, wherein the first indication indicates:
a first timer value controlling a beginning of the first time period; and/or
a second timer value controlling a duration of the first time period.

EE7. The method of any of EE1-EE6, wherein the first time period begins at least this long after the transmission of the one or more indications:
one hour; or
one day; or
one week; or
one month; or
one year.

EE8. The method of any of EE1-EE7, wherein a beginning of the first time period is determined based on a latency requirement of the first WCD and/or of the second WCD.

EE9. A network node (403) configured to perform the method of any of EE1-EE8.

EE10. A network node (403) comprising processing circuitry configured to cause the network node to perform the method of any of EE1-EE8.

### Duty Cycle Supported Access

In some embodiments, the WCD activity over the PC5 interface is restricted by a configured duty cycle (DC). The DC may apply to remote WCDs, to the relay WCD, or to both remote WCDs and relay WCDs. This approach intends to reduce the risk of collisions on the radio interface. A DC of 10% could for example imply that a WCD may either transmit, receive, or transmit and receive in at most 10% of the available time-frequency resources in a determined system bandwidth during a sliding time window, for example of 1 hour.

The DC for a WCD may for example be determined in a specification, or may be preconfigured in the WCD itself, or may be configured by a relay WCD 404 for a remote WCD 401, or may be configured by a network node 403. The DC may for example be configured individually per relay-WCD or per remote WCD.

Part of the remote-WCD transmissions may be contention based, and required to adhere to the mentioned DC constraint. A second part may correspond to transmissions that are not required to follow the DC constraint. The second part may for example correspond to transmission that are scheduled by the relay-WCD.

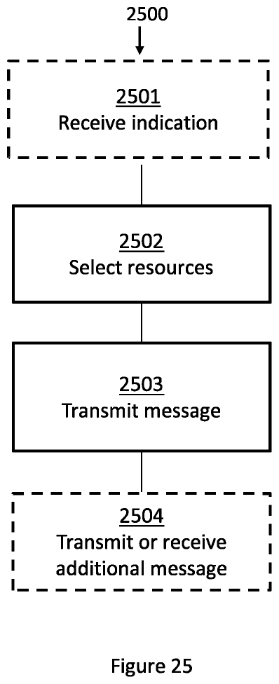

As described above, a duty cycle may be employed to restrict how many resources that can be used by a WCD (such as a UE) to transmit and/or receive transmissions. This idea will be described in more general terms below with reference to FIG. 25.

FIG. 25 is a flow chart of a method 2500 at a first WCD, according to some embodiments. The method 2500 may for example be performed by the first WCD, or by one or more parts/portions/components of the first WCD.

The method 2500 comprises selecting 2502 resources for transmitting one or more messages to a second WCD. The resources may for example include one or more subcarriers in one or more symbols (such as orthogonal frequency division multiplexing (OFDM) symbols) in one or more slots (or in one or more subframes or frames). In other words, the resources may include time and/or frequency resources.

The method 2500 comprises transmitting 2503 the one or more messages to the second WCD on the selected resources (or in the selected resources, or using the selected resources).

At step 2502, the resources are selected from a collection of available resources. The selection of the resources is limited by a threshold for how many of the available resources that are allowed to be occupied by the first WCD during a time period. The threshold may for example be:
at most 20%, or
at most 10%, or
at most 5%, or
at most 1%, or
at most 0.1%, or
at most 0.01%, or
at most 0.001%
   of the available resources during the time period. The time period may for example be a sliding window of a certain length, such as a certain number of symbols, or subframes, or frames, or a certain number of milliseconds, or seconds, or minutes, or hours.

The selecting at step 2502 may for example be performed after a link has been established between the first WCD and the second WCD for relaying of information to a network via one or more sidelink transmissions between the first WCD and the second WCD. For example, a link between the first WCD and the second WCD may have been established via the link establishment procedure described above in the background section with reference to FIG. 2, before the step 2502. This established link may for example be employed by the first WCD to transmit the one or more messages to the second WCD at step 2503.

Alternatively, at least one of the one or more messages transmitted at step 2503 may be part of a link establishment procedure for establishing a link between the first WCD and the second WCD for relaying of information to a network via one or more sidelink transmissions between the first WCD and the second WCD. The one of the one or more messages transmitted at step 2503 may for example include at least one message from the link establishment procedure described above in the background section with reference to FIG.

2. The one of the one or more messages transmitted at step 2503 may for example include:
a direct communication request, or
a direct link authentication request, or
a direct link authentication response, or
a direct link security mode command message, or
a direct link security mode complete message, or
a direct communication accept message, or
a direct link release request, or
a direct link release accept message, or
a direct link keep alive request, or
a direct link keep alive response.

The first WCD may for example select 2502 the resources randomly from the collection of available resources, or may for example use an algorithm to make the selection 2502 in a non-random manner. The collection of available resources may for example be indicated by the second WCD or by a network, or may be determined by the first WCD, or may be predefined. The collection of available resources may for example be fixed, or may change over time.

The first WCD may for example be a remote WCD 401 and the second the second WCD may for example be a relay WCD 404. In other words, the link between the first WCD and the second WCD may be configured for relaying of information from the first WCD to the network via one or more sidelink transmissions from the first WCD to the second WCD. The method 2500 may for example comprise the optional extra step of receiving 2501 an indication from the second WCD indicating
whether or not the threshold is to be employed for the selection 2502 of resources; and/or
which threshold value to be employed for the selection 2502 of resources.

In other words, the relay WCD 404 may indicate to the remote WCD 401 at step 2501 if the selection at step 2502 is to be restricted by a threshold and/or which threshold value (such as 10% or 5%) to be employed. If there are a lot of remote WCDs nearby (for example in the form of IoT devices), the use of resources by the remote WCDs may need to be strictly controlled, for example by use of a low threshold at step 2502. If there are relatively few remote WCDs nearby, the threshold could be lowered, or there may not even be any need to use the threshold at all ay step 2502.

The first WCD may for example be a relay WCD 404 and the second WCD may for example be a remote WCD 401. In other words, the link between the first WCD and the second WCD may be configured for relaying of information from the second WCD to the network via one or more sidelink transmissions from the second WCD to the first WCD. In such a scenario, the indication received at the optional step 2501 may for example be received from the network (such as the network node 403) instead of from the second WCD. In other words, the network node 403 may indicate to the relay WCD 404 at step 2501 if the selection at step 2502 is to be restricted by a threshold and/or which threshold value (such as 10% or 5%) to be employed for the selection.

According to some embodiments, for each of a plurality of time periods, the selection of the resources at step 2502 is limited by a threshold for how many of the available resources that are allowed to be occupied by the first WCD during the respective time period. In other words, the threshold is applied for several time periods. These time periods may for example be mutually disjoint, or at least some of the time periods may be partially overlapping. A sliding window may for example be employed to check that the threshold is maintained at step 2502 for a plurality of time periods of equal length.

According to some embodiments, the method 2500 may comprise the following optional extra steps:
transmitting 2504 an additional message to the second WCD during the time period; and/or
receiving 2504 an additional message from the WCD during the time period.

The one or more resources on which the additional message is transmitted or received are not limited by the threshold for how many of the available resources that are allowed to be occupied by the first WCD during a time period. For example, one type of transmissions (represented by step 2503) may be restricted by a duty cycle constraint, while another type of transmissions (represented by step 2504) may be provided without this restriction.

If the first WCD performing the method 2500 is the remote WCD 401, then the one or more resources on which the additional message is transmitted or received at step 2504 may for example be selected by the second WCD (which in this case would correspond to the relay WCD 404) or by the network. Hence, resources selected by the remote WCD 401 at step 2502 may be constrained by a duty cycle constraint, while resources selected by the relay WCD 404 or the network may be selected without such a constraint. The relay WCD 404 or the network may for example have access to more information than the remote WCD 401 about the risk for collisions, and may be able to schedule transmissions in a suitable way, while the remote WCD 401 may for example schedule transmissions randomly, and may therefore preferably be constrained by a duty cycle threshold.

If the first WCD performing the method 2500 is the relay WCD 404, then the one or more resources on which the additional message is transmitted or received at step 2504 may for example be selected by the network. The network may for example have access to more information than the relay WCD 404 about the risk for collisions, and may be able to schedule transmissions in a suitable way, while the relay WCD 404 may for example schedule transmissions randomly, and may therefore preferably be constrained by a duty cycle threshold.

The first WCD performing the method 2500 may for example perform channel sensing as described above in the background section to figure out which resources are available. However, the first WCD performing the method 2500 could skip the channel sensing, and instead select resources randomly. If channel sensing is not used, the risk of collisions may increase. The use of the threshold at step 2502 may reduce the collision probability, which may for example reduce power consumption.

Further embodiments are provided in the following list of example embodiments (EE).

EE11. A method (2500) at a first wireless communication device (401, 404), WCD, the method comprising:
selecting (2502) resources for transmitting one or more messages to a second WCD (401, 404); and
transmitting (2503) the one or more messages to the second WCD on the selected resources,
   wherein the resources are selected from a collection of available resources, wherein the selection of the resources is limited by a threshold for how many of the available resources that are allowed to be occupied by the first WCD during a time period, and wherein:
the selecting is performed after a link has been established between the first WCD and the second WCD for relaying of information to a network via one or more sidelink transmissions between the first WCD and the second WCD; or
at least one of the one or more messages is part of a link establishment procedure for establishing a link between the first WCD and the second WCD for relaying of information to a network via one or more sidelink transmissions between the first WCD and the second WCD.

EE12. The method of EE11, wherein the link between the first WCD and the second WCD is configured for relaying of information from the first WCD to the network via one or more sidelink transmissions from the first WCD to the second WCD.

EE13. The method of EE12, further comprising
receiving (2501) an indication from the second WCD indicating:
   whether or not the threshold is to be employed for the selection of resources;
   and/or
   which threshold value to be employed for the selection of resources.

EE14. The method of EE11, wherein the link between the first WCD and the second WCD is configured for relaying of information from the second WCD to the network via one or more sidelink transmissions from the second WCD to the first WCD.

EE15. The method of EE14, further comprising receiving (2501) an indication from the network indicating:
whether or not the threshold is to be employed for the selection of resources;
and/or
which threshold value to be employed for the selection of resources.

EE16. The method of any of EE11-EE15, wherein, for each of a plurality of time periods, the selection of the resources is limited by a threshold for how many of the available resources that are allowed to be occupied by the first WCD during the respective time period.

EE17. The method of any of EE11-EE16, wherein the threshold is at most 20%, or at most 10%, or at most 5%, or at most 1%, or at most 0.1%, or at most 0.01%, or at most 0.001% of the available resources during the time period.

EE18. The method of any of EE11-EE17, further comprising:
transmitting (2504) an additional message to the second WCD during the time period; and/or
receiving (2504) an additional message from the WCD during the period, wherein one or more resources on which the additional message is transmitted or received are not limited by the threshold for how many of the available resources that are allowed to be occupied by the first WCD during a time period.

EE19. The method of EE18, wherein the link between the first WCD and the second WCD is configured for relaying of information from the first WCD to the network via one or more sidelink transmissions from the first WCD to the second WCD, and wherein the one or more resources on which the additional message is transmitted or received are selected by the second WCD or by the network.

EE20. The method of EE18, wherein the link between the first WCD and the second WCD is configured for relaying of information from the second WCD to the network via one or more sidelink transmissions from the second WCD to the first WCD, and wherein the one or more resources on which the additional message is transmitted or received are selected by the network.

EE21. A first wireless communication device (401, 404), WCD, configured to perform the method of any of EE10-EE20.

EE22. A first wireless communication device (401, 404), WCD, comprising processing circuitry configured to cause the first WCD to perform the method of any of EE10-EE20.

### Wakeup Signal and Wakeup Radio for Sidelink (SL) Operation

Wake-up radio (WUR) has been used for enabling battery-less IoT devices running on wireless fidelity (WiFi), Bluetooth low energy (BLE), or proprietary connectivity solutions. The power consumption of a WUR can be as low as 1/100th of that required for operating a traditional cellular receiver. This allows a WUR to be always on for detecting a wake-up signal (WUS). Once the WUS is detected, the WUR can alert and turn on the main receiver.

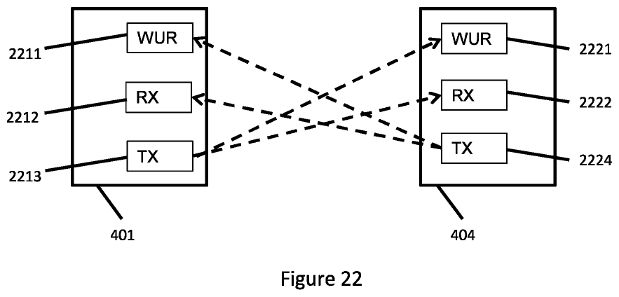

FIG. 22 illustrates a remote WCD 401 and a relay WCD 404 equipped with WUR 2211 and 2221 in addition to ordinary receivers 2212 and 2222, according to some embodiments. The remote WCD 401 corresponds to the remote WCD 401 in FIG. 4. The relay WCD 404 corresponds to the relay WCD 404 in FIG. 4. The WCDs 401 and 404 may also have transmitters 2213 and 2223. It will be appreciated that a receiver and a transmitter may for example be provided together in the form a transceiver.

In one embodiment, the remote WCD 401 turns off the main receiver 2212 and only leaves the WUR 2211 on, once it finishes a data transaction with the relay WCD 404. The relay WCD 404 may configure the remote WCD 401 to detect a remote WCD specific (or group-specific) WUS. The configured WUS may be also used for the remote WCD 401 to wake up the relay WCD 404. When the relay WCD 404 has downlink (DL) data from the network to transmit to the remote WCD 401, it can first send the WUS to wake up the main receiver 2212 of the remote WCD 401. The relay WCD 404 may follow the WUS with transmitting synchronization and/or broadcast signals to facilitate synchronization with the remote WCD 401 and informing the remote WCDs 401 about the radio resources for upcoming communications. After the DL transmission, the remote WCD 401 can also send its uplink (UL) data if needed. Similarly, during sleep, when the remote WCD 401 has UL data for the relay WCD 404, it can first send the WUS to wake up the main receiver 2222 of the relay WCD 404 as the relay WCD 404 may also operate in sleep mode. After wake-up, the relay WCD 404 may transmit synchronization and/or broadcast signals to facilitate synchronization with the remote WCD 401 and informing the remote WCDs 401 about the radio resources for upcoming communications. After the UL transmission, the remote WCD 401 can also stay on for a period of time for DL reachability.

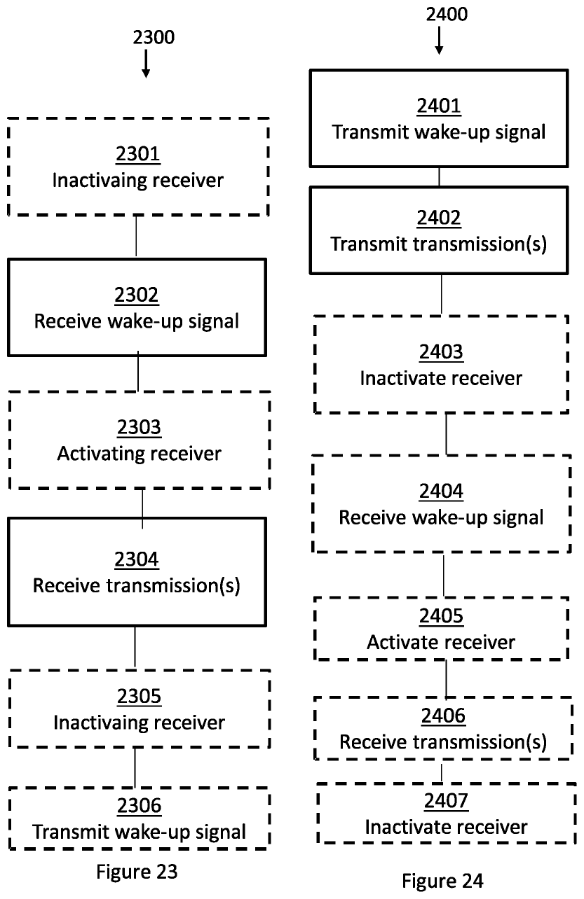

The ideas presented above regarding use of WUR will be now described more generally with reference to FIGS. 23-24.

FIG. 23 is a flow chart of a method 2300 at a first WCD, according to some embodiments. The first WCD comprises a main receiver (such as WUR 2211 or 2221) and an additional receiver (such as RX 2212 or 2222).

The method 2300 comprises receiving 2302, at the additional receiver, a wake-up signal from a second WCD. The wake-up signal may for example comprise a certain sequence of bits and/or one or more certain frequency components. The additional receiver may for example be specifically designed or configured to detect the wake-up signal, but may for example not be able to detect other signals. However, it will be appreciated that the additional receiver could for example be able to detect also other signals than the wake-up signal. The additional receiver may for example comprise receiver circuitry (such as radio circuitry) separate from receiver circuitry (such as radio circuitry) of the main receiver. The additional receiver may for example have lower power consumption than the main receiver.

The method 2300 comprises receiving 2304, at the main receiver, one or more transmissions from the second WCD after the wake-up signal has been received at the additional receiver.

The wake-up signal is received after a link has been established between the first WCD and the second WCD for relaying of transmissions to a network via one or more sidelink transmissions between the first WCD and the second WCD. For example, a link between the first WCD and the second WCD may have been established via the link establishment procedure described above in the background section with reference to FIG. 2, before the step 2302. This established link may for example be employed by the first WCD to receive the one or more transmissions from the second WCD at step 2304.

The method 2300 may for example comprise activating 2303 the main receiver in response to receipt of the wake-up signal at step 2302, for example by turning on the main receiver or turning on power to the main receiver or waking the main receiver from a power saving mode. Other parts of the first WCD may for example also be activated in response to receipt of the wake-up signal.

The main receiver may for example have been inactivated 2301 prior to receiving the wake-up signal. The first WCD may for example have inactivated the main receiver when it was not needed any more, such as after the WCD transmitted or received a transmission. In other words, the method 2300 may optionally comprise:
inactivating the main receiver after transmitting to the second WCD; or
inactivating the main receiver a certain time after transmitting to the second WCD; or
inactivating the main receiver after receiving a transmission from the second WCD; or
inactivating the main receiver a certain time after receiving a transmission from the second WCD.

After receiving the one or more transmissions at step 2304, the first WCD may for example inactivate 2305 the main receiver.

Prior to receiving the wake-up signal at the additional receiver at step 2302, the first WCD may for example be configured with the wake-up signal by the second WCD. The second WCD may for example transmit the configuration of the wake-up signal to the first WCD and the first WCD may for example receive the configuration at the main receiver or at the additional receiver.

The first WCD may for example be the remote WCD 401 and the second WCD may for example be the relay WCD 404. The link between the first WCD and the second WCD may then be configured for relaying of information from the first WCD (the remote WCD 401) to the network via one or more sidelink transmissions from the first WCD to the second WCD (the relay WCD 404). The one or more transmissions received at step 2304 may for example include synchronization signaling from the second WCD. The method 2300 may for example comprise synchronizing with the second WCD based on the synchronization signaling. The synchronization signaling may for example include a sidelink synchronization signal block (SL-SSB). The one or more transmissions received at step 2304 may for example include a message transmitted by the second WCD for receipt by multiple WCDs (such as a broadcast message or multicast message), wherein the message indicates a collection of resources available for transmission between the first WCD and the second WCD. The method 2300 may for example comprise transmitting a transmission to the second WCD in one or more resources from the indicated collection of resources, and/or receiving a transmission from the second WCD in one or more resources from the indicated collection of resources.

The first WCD may for example be the relay WCD 404 and the second WCD may for example be the remote WCD 401. The link between the first WCD and the second WCD may then be configured for relaying of information from the second WCD (the remote WCD 401) to the network via one or more sidelink transmissions from the second WCD to the first WCD (the relay WCD 404).

The method 2300 may for example comprise transmitting 2306 a wake-up signal to the second WCD. The wake-up signal used as step 2306 may for example be the same wake-up signal as the wake-up signal used at step 2302, or may be a different wake-up signal.

FIG. 24 is a flow chart of a method 2400 at a second WCD, according to some embodiments. The second WCD comprises a main receiver (such as WUR 2211 or 2221) and an additional receiver (such as RX 2212 or 2222).

The method 2400 comprising transmitting 2401 a wake-up signal to a first WCD. The wake-up signal transmitted at step 2401 may for example be the same wake-up signal as received at step 2302 in the method 2300.

The method 2400 comprises transmitting 2402 one or more transmissions to the first WCD after transmitting the wake-up signal. The one or more transmission transmitted at step 2402 may for example be the same transmission(s) as received at step 2304 in the method 2300.

The wake-up signal is transmitted after a link has been established between the first WCD and the second WCD for relaying of information to a network via one or more sidelink transmissions between the first WCD and the second WCD. For example, a link between the first WCD and the second WCD may have been established via the link establishment procedure described above in the background section with reference to FIG. 2, before the step 2401. This established link may for example be employed by the second WCD to transmit the one or more transmissions to the first WCD at step 2402.

The second WCD may for example have configured the first WCD with the wake-up signal prior to transmitting the wake-up signal to the first WCD at step 2401,

The first WCD may for example be the remote WCD 401 and the second WCD may for example be the relay WCD 404. The link between the first WCD and the second WCD may then be configured for relaying of information from the first WCD (the remote WCD 401) to the network via one or more sidelink transmissions from the first WCD to the second WCD (the relay WCD 404). The one or more transmissions transmitted at step 2402 may for example include synchronization signaling. The one or more transmissions transmitted at step 2402 may for example include a message transmitted by the second WCD for receipt by multiple WCDs (such as such as a broadcast message or multicast message), wherein the message indicates a collection of resources for transmission between the WCDs and the second WCD. The method 2400 may for example comprise receiving a transmission from the first WCD in one or more resources from the collection indicated of resources, and/or transmitting a transmission to the first WCD in one or more resources from the indicated collection of resources.

The first WCD may for example be the relay WCD 404 and the second WCD may for example be the remote WCD 401. The link between the first WCD and the second WCD may then be configured for relaying of information from the second WCD (the remote WCD 401) to the network via one or more sidelink transmissions from the second WCD to the first WCD (the relay WCD 404).

The second WCD that performs the method 2400 may for example comprise a main receiver (such as WUR 2211 or 2221) and an additional receiver (such as RX 2212 or 2222). The method 2400 may for example comprise
receiving 2404, at the additional receiver, the wake-up signal from the first WCD; and
receiving 2406, at the main receiver, one or more transmissions from the first WCD
after the wake-up signal has been received at the additional receiver.

The wake-up signal used as step 2404 may for example be the same wake-up signal as the wake-up signal used at step 2401, or may be a different wake-up signal.

The method 2400 may for example comprise activating 2405 the main receiver in response to receipt of the wake-up signal at step 2404, for example by turning on the main receiver or turning on power to the main receiver or waking the main receiver from a power saving mode. Other parts of the second WCD may for example also be activated in response to receipt of the wake-up signal.

The main receiver may for example have been inactivated 2403 prior to receiving the wake-up signal. The second WCD may for example have inactivated the main receiver when it was not needed any more, such as after the second WCD transmitted or received a transmission. In other words, the method 2400 may optionally comprise:
inactivating the main receiver after transmitting to the first WCD; or
inactivating the main receiver a certain time after transmitting to the first WCD; or
inactivating the main receiver after receiving a transmission from the first WCD; or
inactivating the main receiver a certain time after receiving a transmission from the first WCD.

After receiving the one or more transmissions at step 2406, the second WCD may for example inactivate 2407 the main receiver.

Further embodiments are provided in the following list of example embodiments (EE).

EE23. A method (2300) at a first wireless communication device (401, 404), WCD, wherein the first WCD comprises a main receiver (2212, 2222) and an additional receiver (2211, 2221), wherein the method comprises:
receiving (2302), at the additional receiver, a wake-up signal from a second WCD (401, 402); and
receiving (2304), at the main receiver, one or more transmissions from the second WCD after the wake-up signal has been received at the additional receiver, wherein the wake-up signal is received after a link has been established between the first WCD and the second WCD for relaying of information to a network via one or more sidelink transmissions between the first WCD and the second WCD.

EE24. The method of EE23, further comprising:
activating (2303) the main receiver in response to receipt of the wake-up signal.

EE25. The method of any of EE23-EE24, further comprising:
inactivating the main receiver after transmitting to the second WCD; or
inactivating the main receiver a certain time after transmitting to the second WCD; or
inactivating the main receiver after receiving a transmission from the second WCD; or
inactivating the main receiver a certain time after receiving a transmission from the second WCD.

EE26. The method of any of EE23-EE25, further comprising, prior to receiving the wake-up signal at the additional receiver,
being configured with the wake-up signal by the second WCD.

EE27. The method of any of EE23-EE26, wherein the link between the first WCD and the second WCD is configured for relaying of information from the first WCD to the network via one or more sidelink transmissions from the first WCD to the second WCD.

EE28. The method of EE27, wherein the one or more transmissions include synchronization signaling from the second WCD, the method further comprising:
synchronizing with the second WCD based on the synchronization signaling.

EE29. The method of any of EE27-EE28, wherein the one or more transmissions include a message transmitted by the second WCD for receipt by multiple WCDs, wherein the message indicates a collection of resources for transmission between the first WCD and the second WCD, the method further comprising:
transmitting to the second WCD in one or more resources from the collection of resources; and/or
receiving a transmission from the second WCD in one or more resources from the collection of resources.

EE30. The method of any of EE23-EE26, wherein the link between the first WCD and the second WCD is configured for relaying of information from the second WCD to the network via one or more sidelink transmissions from the second WCD to the first WCD.

EE31. The method of any of EE23-EE30, further comprising:
transmitting (2306) a wake-up signal to the second WCD.

EE32. A method (2400) at a second wireless communication device (401, 404), WCD, the method comprising:
transmitting (2401) a wake-up signal to a first WCD (401, 402); and
transmitting (2402) one or more transmissions to the first WCD after transmitting the wake-up signal,
   wherein the wake-up signal is transmitted after a link has been established between the first WCD and the second WCD for relaying of information to a network via one or more sidelink transmissions between the first WCD and the second WCD.

EE33. The method of EE32, further comprising, prior to transmitting the wake-up signal to the first WCD,
configuring the first WCD with the wake-up signal.

EE34. The method of any of EE32-EE33, wherein the link between the first WCD and the second WCD is configured for relaying of information from the first WCD to the network via one or more sidelink transmissions from the first WCD to the second WCD.

EE35. The method of claim EE34, wherein the one or more transmissions include synchronization signaling.

EE36. The method of any of EE34-EE35, wherein the one or more transmissions include a message transmitted by the second WCD for receipt by multiple WCDs, wherein the message indicates a collection of resources for transmission between the first WCD and the second WCD, the method further comprising:
receiving a transmission from the first WCD in one or more resources from the collection of resources; and/or
transmitting to the first WCD in one or more resources from the collection of resources.

EE37. The method of any of EE32-EE33, wherein the link between the first WCD and the second WCD is configured for relaying of information from the second WCD to the network via one or more sidelink transmissions from the second WCD to the first WCD.

EE38. The method of any of EE32-EE37, wherein the second WCD comprises a main receiver (2212, 2222) and an additional receiver (2211, 2221), wherein the method further comprises:
receiving (2404), at the additional receiver, the wake-up signal from the first WCD; and
receiving (2406), at the main receiver, one or more transmissions from the first WCD after the wake-up signal has been received at the additional receiver.

EE39. The method of EE38, further comprising:
activating (2405) the main receiver in response to receipt of the wake-up signal.

EE40. The method of any of EE38-EE39, further comprising:
inactivating the main receiver after transmitting to the first WCD; or
inactivating the main receiver a certain time after transmitting to the first WCD; or
inactivating the main receiver after receiving a transmission from the first WCD; or
inactivating the main receiver a certain time after receiving a transmission from the first WCD.

EE41. A first wireless communication device (401, 404), WCD, configured to perform the method of any of EE23-EE31.

EE42. A first wireless communication device (401, 404), WCD, comprising processing circuitry configured to cause the first WCD to perform the method of any of EE23-EE31.

EE43. A second wireless communication device (401, 404), WCD, configured to perform the method of any of EE32-EE40.

EE44. A second wireless communication device (401, 404), WCD, comprising processing circuitry configured to cause the second WCD to perform the method of any of EE32-EE40.

### Network Control Functionality

In at least some embodiments, the network determines if a relay WCD 404 may attach to the network. In at least some embodiments, it is up to network control which of the different solutions (presented in the preceding sections of the detailed description) should be applied by the relay WCD 404 and the remote WCD 401. In one example, a request from the relay WCD 404 to the gNodeB 403 is transmitted to ask permission to act as a relay. Additional information can for example be included with the request, such as which solutions to apply, whether to use gNodeB controlled radio resources or using a pre-determined pool of radio resources (mode 1 or mode 2), etc. The gNodeB then either grants or denies this request and can include the configuration which the relay WCD 404 should apply, for example with regard to which solution to apply (such as remote WCD 404 resource allocation with or without channel sensing, mode 1 or mode 2 radio resource allocation, SL-PSM or SL-DRX, etc.

Hence, any of the methods described above and performed a relay WCD 404, may optionally comprise:
transmitting a request to the network node 403 for permission to act as a relay for information from one or more other WCDs; and
receiving a grant or rejection from the network node 403.

Additionally or alternatively, any of the methods described above and performed a relay WCD 404, may optionally comprise:
receiving, from the network node 403 in a network, an indication regarding which of a collection of approaches to apply for communicating with the remote WCD 401 for relaying of information from the remote WCD 401 to the network.

Such methods may for example also comprise:
providing, to the remote WCD 401, an indication regarding which of a collection of approaches to apply for communicating with the relay WCD 404 for relaying of information from the remote WCD 401 to a network via the relay WCD 404.

Any of the methods described above and performed by a remote WCD 401, may optionally comprise:
receiving, from the relay WCD 404 or from the network node 403, an indication which of a collection of approaches to apply for communicating with the relay WCD 404 for relaying of information from the remote WCD 401 to a network via the relay WCD 404.

The collection of approaches referred to in the method steps above may for example include one or more of the approaches described in the preceding sections of the detailed description.

### Embodiments of WCDs, Network Nodes, Computer Programs Etc

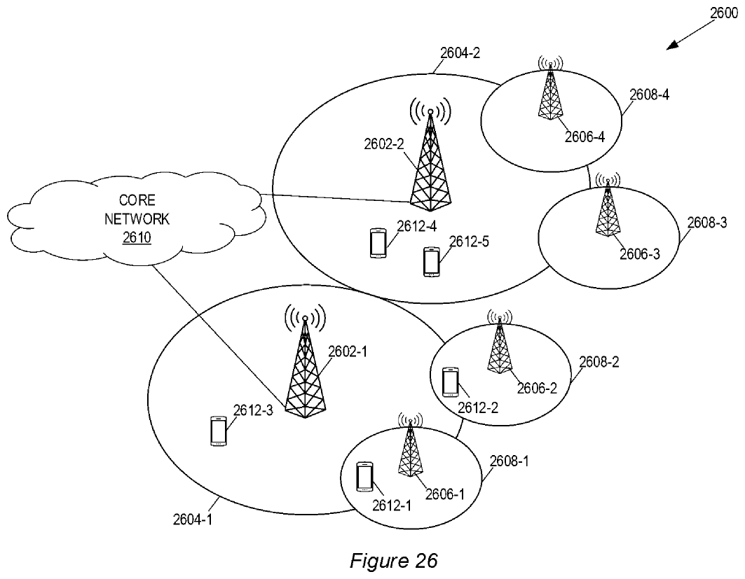

FIG. 26 illustrates an example of a communications network (or communications system) 2600 in which embodiments of the present disclosure may be implemented. In the present example, the communication network 2600 is a cellular communication system, such as a 5G system (5GS) including a Next Generation RAN (NG-RAN) (also referred to herein as a NR RAN), an Evolved Packet System (EPS) including an LTE RAN, or the like. In the present example, the RAN includes base stations 2602-1 and 2602-2, which in the NG-RAN are referred to as gNBs (NR base station) or ng-eNBs (LTE RAN nodes connected to 5GC) and in the LTE RAN are referred to as eNBs, controlling corresponding (macro) cells 2604-1 and 2604-2. The base stations 2602-1 and 2602-2 are generally referred to herein collectively as base stations 2602 and individually as base station 2602. Likewise, the (macro) cells 2604-1 and 2604-2 are generally referred to herein collectively as (macro) cells 2604 and individually as (macro) cell 2604. The RAN may also include a number of low power nodes 2606-1 through 2606-4 controlling corresponding small cells 2608-1 through 2608-4. The low power nodes 2606-1 through 2606-4 can be small base stations (such as pico or femto base stations) or Remote Radio Heads (RRHs), or the like. Notably, while not illustrated, one or more of the small cells 2608-1 through 2608-4 may alternatively be provided by the base stations 2602. The low power nodes 2606-1 through 2606-4 are generally referred to herein collectively as low power nodes 2606 and individually as low power node 2606. Likewise, the small cells 2608-1 through 2608-4 are generally referred to herein collectively as small cells 2608 and individually as small cell 2608. The communications network 2600 also includes a core network 2610, which in the 5GS is referred to as the 5G core (5GC). The base stations 2602 (and optionally the low power nodes 1406) are connected to the core network 2610.

The base stations 2602 and the low power nodes 2606 provide service to wireless communication devices (WCDs) 2612-1 through 2612-5 in the corresponding cells 2604 and 2608. The WCDs 2612-1 through 2612-5 are generally referred to herein collectively as WCDs 2612 and individually as WCD 2612. The WCDs 2612 may for example be UEs, but the present disclosure is not limited thereto. The first WCD 401 and/or the second WCD 404 described above with reference to FIG. 4 may for example be one of the WCDs 2612 in FIG. 26. The network node 403 described above with reference to FIG. 4 may for example be one of the base stations 2602 or the low power nodes 2606 in FIG. 26.

The methods 600, 700, 2300, 2400 and 2500 described above with reference to FIGS. 6-12, 16-21 and 23-25 represent method aspects of the present disclosure. The WCDs 401 and 404 described above with reference to FIGS. 4 and 22 represent apparatus aspects of the present disclosure. The WCD 401 or 404 may for example be configured to perform the method of any of the embodiments (or example implementations) of the method aspects described above. The WCD 401 or 404 may for example be configured to perform the method 600 or 700 (with or without any of the optional features described above).

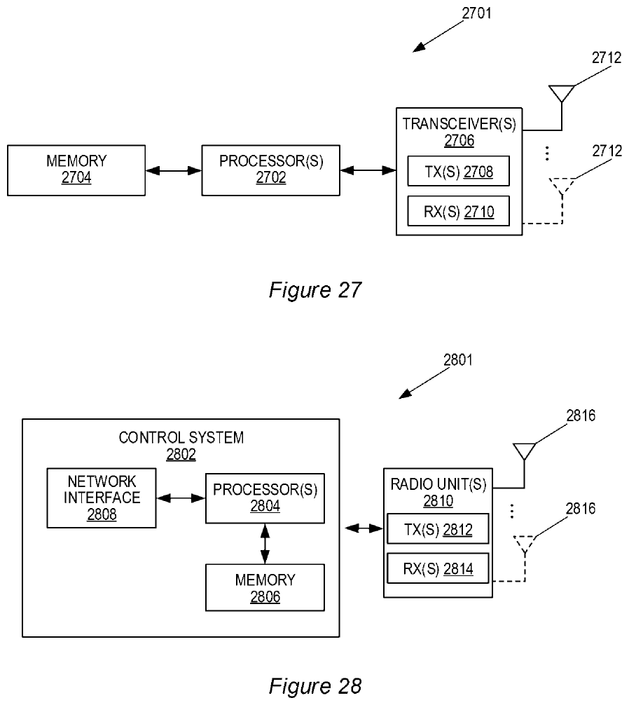

The WCD 401 or 404 may for example comprise means configured to cause the WCD 401 or 404 to perform the method of any of the embodiments (or example implementations) of the method aspects described above. It will be appreciated that the WCD 401 or 404 in FIG. 4 need not necessarily comprise all those components described below with reference to FIG. 27.

The WCD 401 or 404 may for example comprise processing circuitry (or one or more processors) configured to cause the WCD 401 or 404 to perform the method of any of the embodiments (or example implementations) of the method aspects described above.

The WCD 401 or 404 may for example comprise processing circuitry (or one or more processors) and a memory, the memory containing instructions executable by the processing circuitry whereby the WCD 401 or 404 is operative to perform the method of any of the embodiments (or example implementations) of the method aspects described above.

In some embodiments, a computer program includes instructions which, when executed by processing circuitry (or one or more processors), cause the processing circuitry to carry out the functionality of the WCD 401 or 404 according to the method of any of the embodiments (or example implementations) of the method aspects described above.

In some embodiments, a carrier comprises the aforementioned computer program. The carrier is one of an electronic signal, an optical signal, a radio signal, or a computer readable storage medium (for example a non-transitory computer readable medium such as memory).

FIG. 27 is a schematic block diagram of a WCD 2701 according to some embodiments of the present disclosure. The remote WCD 401 and/or the relay WCD 404, described above with reference to FIG. 4, may for example be of the same type as the WCD 2701. As illustrated, the WCD 2701 includes one or more processors 2702 (for example Central Processing Units (CPUs), Application Specific Integrated Circuits (ASICs), Field Programmable Gate Arrays (FPGAs), and/or the like), one or more memories 2704 (for example Read Only Memories (ROMs), Random Access Memories (RAMs), cache memories, flash memory devices, optical storage devices, and/or the like), and one or more transceivers 2706 each including one or more transmitters 2708 and one or more receivers 2710 coupled to one or more antennas 2712. The transceiver(s) 2706 includes radio-front end circuitry connected to the antenna(s) 2712 that is configured to condition signals communicated between the antenna(s) 2712 and the processor(s) 2702, as will be appreciated by those of ordinary skill in the art. The processor(s) 2702 is also referred to herein as processing circuitry. The transceiver(s) 2706 is also referred to herein as radio circuitry. In some embodiments, the functionality of the WCD 2701 described above may be fully or partially implemented in software (that is, for example stored in the memory 2704 and executed by the processor(s) 2702). Note that the WCD 2701 may include additional components not illustrated in FIG. 27 such as, for example, one or more user interface components (for example an input/output interface including a display, buttons, a touch screen, a microphone, a speaker(s), and/or the like and/or any other components for allowing input of information into the WCD 2701 and/or allowing output of information from the WCD 2701), a power supply (for example a battery and associated power circuitry), etc.

FIG. 28 is a schematic block diagram of a network node 2801 according to some embodiments of the present disclosure. The network node 403 described above with reference to FIG. 4 may for example be of the same type as the network node 2801. The network node 2801 may be, for example, a base station 2602 or 2606 or a network node that implements all or part of the functionality of a base station. As illustrated, the network node 2801 includes a control system 2802 that includes one or more processors 2804 (for example CPUs, ASICs, FPGAs, and/or the like), one or more memories 2806 (for example ROMs, RAMs, cache memories, flash memory devices, optical storage devices, and/or the like), and a network interface 2808. The one or more processors 2804 are also referred to herein as processing circuitry. In addition, the network node 2801 includes one or more radio units 2810 that each includes one or more transmitters 2812 and one or more receivers 2814 coupled to one or more antennas 2816. The radio unit(s) 2810 may be referred to or be part of radio interface circuitry. In some embodiments, the radio unit(s) 2810 is external to the control system 2802 and connected to the control system 2802 via, for example, a wired connection (for example, an optical cable). However, in some other embodiments, the radio unit(s) 2810 and potentially the antenna(s) 2816 are integrated together with the control system 2802. The one or more processors 2804 operate to provide one or more functions of a network node 2801 as described herein. In some embodiments, the function(s) are implemented in software that is stored, for example, in the memory 2806 and executed by the one or more processors 2804.

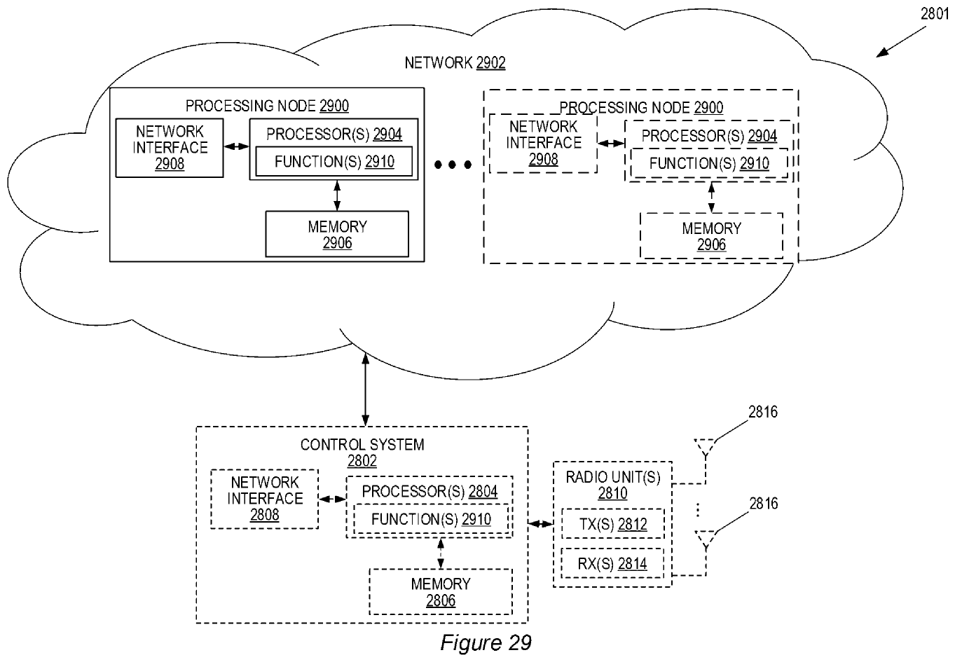

FIG. 29 is a schematic block diagram that illustrates a virtualized embodiment of the network node 2801 according to some embodiments of the present disclosure. As used herein, a “virtualized” network node is an implementation of the network node 2801 in which at least a portion of the functionality of the network node 2801 is implemented as a virtual component(s) (for example via a virtual machine(s) executing on a physical processing node(s) in a network(s)). As illustrated, in this example, the network node 2801 includes one or more processing nodes 2900 coupled to or included as part of a network(s) 2902. Each processing node 2900 includes one or more processors 2904 (for example, CPUs, ASICs, FPGAs, and/or the like), one or more memories 2906 (for example ROMs, RAMs, cache memories, flash memory devices, optical storage devices, and/or the like), and a network interface 2908. The network node 2801 may include the control system 2802 and/or the one or more radio units 2810, as described above. If present, the control system 2802 or the radio unit(s) 2810 are connected to the processing node(s) 2900 via the network 2902. In this example, functions 2910 of the network node 2801 described herein are implemented at the one or more processing nodes 2900 or distributed across the one or more processing nodes 2900 and the control system 2802 and/or the radio unit(s) 2810 in any desired manner. In some particular embodiments, some or all of the functions 2910 of the network node 2801 described herein are implemented as virtual components executed by one or more virtual machines implemented in a virtual environment(s) hosted by the processing node(s) 2900.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure. The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method at a first wireless communication device, WCD, the method comprising:
transmitting a first indication to a second WCD or receiving a first indication from a second WCD, wherein the first indication indicates a first time period during which the first WCD is expected to monitor for receipt of a transmission; and
monitoring for receipt of a transmission during the first time period,
wherein the first WCD is not expected to monitor for receipt of a transmission during a second time period before the first time period begins, and wherein the transmitting or receiving of the first indication is performed after a link has been established between the first WCD and the second WCD for relaying of information to and/or from a network via one or more sidelink transmissions between the first WCD and the second WCD.

2. The method of claim 1, wherein a receiver of the first WCD is inactive during at least a portion of the second time period.

3. The method of claim 1, wherein a receiver of the first WCD is inactive from the transmission or receipt of the first indication until the first time period begins.

4. The method of claim 1, comprising:
receiving a second indication from the network, wherein the second indication indicates the first time period; and
transmitting the first indication to the second WCD.

5. The method of claim 1, comprising:
transmitting a message to the network;
restarting a timer that indicates a beginning of the first time period; and
transmitting the first indication to the second WCD.

6. (canceled)

7. The method of claim 1, further comprising:
receiving a third indication from the second WCD or the network, wherein the third indication indicates transmission of a message by the second WCD to the network; and
restarting a timer indicating a beginning of an on-period of the second WCD.

8. (canceled)

9. The method of claim 1, further comprising:
transmitting a fourth indication to the second WCD or receiving a fourth indication from the second WCD, wherein the fourth indication indicates a third time period during which the second WCD is expected to monitor for receipt of a transmission.

10.-16. (canceled)

17. The method of claim 1, wherein the first WCD employs a periodic registration timer for communication with a network node of the network, wherein the first time period is coordinated with the periodic registration timer.

18. The method of claim 17, wherein the first time period begins when the periodic registration timer expires.

19. The method of claim 1, wherein the first WCD employs a discontinuous reception, DRX, cycle for communication with a network node (403) of the network, wherein the first time period is coordinated with the DRX cycle.

20.-28. (canceled)

29. The method of claim 1, further comprising:
transmitting a fifth indication to the second WCD or receiving a fifth indication from the second WCD, wherein the fifth indication indicates a fifth time period during which the first WCD is expected to monitor for receipt of a transmission after transmitting a message to the second WCD;
transmitting a message to the second WCD; and
monitoring for receipt of a transmission during the fifth time period after transmitting the message to the second WCD.

30. The method of claim 1, wherein the first time period begins at least this long after the transmission or receipt of the first indication:
one minute; or
one hour; or
one day; or
one week; or
one month; or
one year.

31. (canceled)

32. A method at a second wireless communication device, WCD, the method comprising:
transmitting a first indication to a first WCD or receiving a first indication from a first WCD, wherein the first indication indicates a first time period during which the first WCD is expected to monitor for receipt of a transmission; and
transmitting to the first WCD during the first time period,
wherein the first WCD is not expected to monitor for receipt of a transmission during a second time period before the first time period begins, and wherein the transmitting or receiving of the first indication is performed after a link has been established between the first WCD and the second WCD for relaying of information to and/or from a network via one or more sidelink transmissions between the first WCD and the second WCD.

33.-65. (canceled)

66. A first wireless communication device, WCD, comprising processing circuitry configured to cause the first WCD to:
transmit a first indication to a second WCD or receive a first indication from a second WCD, wherein the first indication indicates a first time period during which the first WCD is expected to monitor for receipt of a transmission; and
monitor for receipt of a transmission during the first time period,
wherein the first WCD is not expected to monitor for receipt of a transmission during a second time period before the first time period begins, and wherein the processing circuitry is configured to cause the first WCD to perform the transmission or receipt of the first indication after a link has been established between the first WCD and the second WCD for relaying of information to and/or from a network via one or more sidelink transmissions between the first WCD and the second WCD.

67.-69. (canceled)

70. A second wireless communication device, WCD, comprising processing circuitry configured to cause the second WCD to:
transmit a first indication to a first WCD or receive a first indication from a first WCD, wherein the first indication indicates a first time period during which the first WCD is expected to monitor for receipt of a transmission; and
transmit to the first WCD during the first time period,
wherein the first WCD is not expected to monitor for receipt of a transmission during a second time period before the first time period begins, and wherein the processing circuitry is configured to cause the second WCD to perform the transmission or receipt of the first indication after a link has been established between the first WCD and the second WCD for relaying of information to and/or from a network via one or more sidelink transmissions between the first WCD and the second WCD.

71. (canceled)
